(19) United States
(12) Patent Application Publication
(10) Pub. No.: US 2018/0224945 A1
(43) Pub. Date: Aug. 9, 2018

(54) Updating a Virtual Environment

(71) Applicant: Anthony Richard Hardie-Bick, London (GB)

(72) Inventor: Anthony Richard Hardie-Bick, London (GB)

(21) Appl. No.: 15/886,310

(22) Filed: Feb. 1, 2018

(30) Foreign Application Priority Data
Feb. 5, 2017 (GB) 1701877.1
Nov. 3, 2017 (GB) 1718258.5

(51) Int. Cl. G06F 3/01; G06T 19/00

(52) U.S. Cl. CPC G06F 3/017; G06F 3/011; G06T 19/003; G06F 3/016; G06T 19/006

(57) ABSTRACT

A system for presenting immersive images to a user via a display device, in which the user has a viewpoint within a three-dimensional virtual environment, the system including a substantially spherical manually-rotatable hand supported input device with a rotation-detector, a device-processor and a wireless transmitter, in which the device-processor generates gestural-data in response to manual rotation of the input device measured by the rotation-detector, and the transmitter transmits the gestural-data; an external-processing-device which receives the gestural-data wirelessly, moves the user viewpoint in the three-dimensional virtual environment in response to manual rotation of the input device and renders image-data from the virtual environment with respect to the viewpoint; and a display device, in which the display device presents the image data to a user; in which the user experiences locomotion within the virtual environment in response to rotation of the input device.

### CROSS REFERENCE TO RELATED APPLICATIONS

This application represents the second application for a patent directed towards the invention and the subject matter, and claims priority from UK Patent Application Numbers GB1701877.1 filed on 5 Feb. 2017 and GB1718258.5 filed on 3 Nov. 2017.

### BACKGROUND OF THE INVENTION

### 1. Field of the Invention

The present invention relates to navigating a three-dimensional environment, and in particular relates to moving the user's viewpoint in a three-dimensional environment in response to gestures made with an input device.

### 2. Description of the Related Art

The computer mouse has revolutionised desktop computing, and the touch screen has more recently revolutionised mobile computing. These two input methods highlight the way that certain devices can transform advanced technologies from being exclusively scientific tools into low cost everyday items that can directly benefit a very large number of people. In spite of diverse research efforts, there is no known universal input device for navigating three-dimensional environments, such as those used for virtual reality, that has had the same enabling effect. Such environments are presented with increasingly high quality due to the ontinuing decrease in cost of graphics processors in accordance with Moore's Law. Displays more than a meter across are increasingly commonplace consumer products. Virtual environments displayed on them must be navigated using a joystick, or a mouse and keyboard, or any one of several specialised input technologies.

Examples of virtual environments include many kinds of computer games, three-sixty degree videos and photographs, and hybrid systems, such as Google Earth, that combine projections of photography with terrain data to simulate a fly-through. Anyone with a web browser can rotate, zoom and otherwise navigate these virtual environments. In many cases, a keyboard and mouse, or just a keyboard, can be used to rotate and move the user's point-of-view. However, these methods of navigation are very different from the sensation of walking through an environment in the real world. Another kind of virtual environment is a remote environment, where cameras and other sensors supply data to a user's location, such that the user feels as if he or she is actually present in the remote environment. Another kind of virtual environment is the environment of a remotely piloted aircraft, such as a drone. The environment may be presented to the pilot on a display that shows images from a camera on the drone. Alternatively, the pilot flies the drone by looking at it from a distance.

One attempt to present virtual environments that are more convincing is to use a stereoscopic headset, replacing most of the user's field of view with a pair of synthetic images, one for each eye. Head movements may be tracked so that the images supplied to each eye are updated as if the user is located in the virtual environment, giving a sense of immersion. Although the sense of immersion can be profound, it is easily broken when moving around in the virtual environment, due to the nature of input devices used to facilitate such movement. Furthermore, a headset isolates the user off from their immediate environment, and may be uncomfortable to wear for extended periods of time.

Movement of a user's point of view in a virtual environment is known as locomotion. The problem of locomotion in virtual reality (VR) is widely considered to be a significant obstacle to its adoption. However, more generally, user movement in any kind of three-dimensional environment lacks a universal input device analogous to the mouse or touch screen.

Several solutions to the problem of locomotion in VR have been proposed. For example, the virtual environment can be navigated using room-scale tracking, in which the user walks around a room in the real world, and their location in the virtual world is updated according to their real world location. Room-scale tracking is prohibitive for all but the most dedicated of users, because it requires an entire room to be mostly cleared of obstacles. Furthermore, part of the attraction of virtual environments is that their size is potentially unlimited, and the need to restrict user movement to the area of a room prevents this from being achieved in practice.

Other hardware locomotion solutions include various kinds of joystick input devices, including those present on controllers used with game consoles. Although these are ideal for many kinds of gaming, the resulting way in which the virtual environment is navigated is entirely different from natural movement in the real world. This is because the position of the joystick determines acceleration or velocity, rather than location. If a joystick were to be used to control location, the range of movement would be limited to a very small area.

A further possibility, now widely used in VR gaming, is a software locomotion technique, known as virtual teleportation. In this method of locomotion, the user indicates a distant location, and they are instantly moved to that location, possibly including some kind of animation to show to the user that their location has changed, and in what direction their point of view has been moved. Teleportation greatly reduces the user's sense of immersion; it solves the problem of locomotion by avoiding natural movement entirely.

Another proposed solution is the omnidirectional treadmill, such as the Virtuix Omni™. A treadmill is expensive and large, but it does serve to illustrate the effort that has been applied to solve the problem of locomotion in VR.

In U.S. Pat. No. 6,891,527 B1 a hand-held spherical input device is described. Mouse cursor movements are obtained by tracking the location of a fingertip on a touch sensitive surface that covers the sphere. However, gestures for navigating a three dimensional virtual environment are not described. In 2011, a proposal was made for a universal spherical input device, available at http://lauralahti.com/The-Smartball. This hand-held input device is also spherical, and is described as having applications in 3D development and augmented reality, by virtue of the ability to manipulate a virtual object using pinch, pull and grab gestures. However, the use of the device for movement of the user's point of view is not described.

The requirement to wear a VR headset greatly limits the circumstances in which virtual environments can be viewed and navigated. However, a headset does solve the problem of being able to look at the virtual environment from any angle. Clearly it would be preferable to be able to look around just as easily without having to put on a VR headset, and also to move in the virtual environment just as easily as one moves in the real world.

### BRIEF SUMMARY OF THE INVENTION

According to an aspect of the present invention, there is provided an apparatus for supplying gestural-data to an external-processing-device thereby allowing the external-processing-device to move a viewpoint in a three-dimensional virtual environment and to render the virtual environment from the viewpoint, implemented as a substantially spherical manually-rotatable input device supported in the hands of a user, comprising a rotation-detector configured to generate gestural-data in response to manual rotation and a wireless transmitter for transmitting the gestural-data to the external-processing-device. Preferably the rotation-detector is an inertial-measurement-unit and the input device further comprises a hand-area-sensor and is configured to generate additional gestural-data in response to measurements made with the hand-area-sensor.

According to another aspect of the present invention, there is provided a method of adjusting the location of a viewpoint in a three-dimensional environment, comprising the steps of generating rotation-data in response to a manual rotation of a substantially spherical hand-supported input device supported in the hands of a user, wirelessly transmitting the rotation-data to an external-processing-device, and moving the location of a viewpoint in the three-dimensional environment in response to the received rotation-data. Preferably the method includes rendering image data from the three-dimensional environment with respect to the viewpoint location and displaying the image data to the user. Preferably, the step of moving the location includes the steps of moving the viewpoint forwards in the virtual environment in response to a pitch-rotation of the input device about an x axis, translating the viewpoint sideways in the virtual environment in response to a roll-rotation of the input device about a z-axis, and yaw-rotating the viewpoint in the virtual environment in response to a yaw-rotation of the input device about a y-axis.

According to another aspect of the present invention, there is provided a system for presenting immersive images to a user via a display device, in which the user has a viewpoint within a three-dimensional virtual environment, the system comprising a substantially spherical manually-rotatable hand supported input device with a rotation-detector, a device-processor and a wireless transmitter, wherein the device-processor generates gestural-data in response to manual rotation of the input device measured by the rotation-detector, and the transmitter transmits the gestural-data, the system further comprising an external-processing-device, which receives the gestural-data wirelessly, moves the user viewpoint in the three-dimensional virtual environment in response to manual rotation of the input device and renders image-data from the virtual environment with respect to the viewpoint, and a display device, in which the display device presents the image data to a user such that the user experiences locomotion within the virtual environment in response to their rotation of the input device. Preferably the external-processing-device is configured to move the viewpoint forwards in the virtual environment in response to a pitch-rotation of the input device about an x-axis, translate the viewpoint sideways in the virtual environment in response to a roll-rotation of the input device about a z-axis, and yaw-rotate the viewpoint in the virtual environment in response to a yaw-rotation of the input device about a y-axis.

### BRIEF DESCRIPTION OF THE DRAWINGS

FIG. 1 shows a user manipulating an input device, a receiver, a virtual environment and an external-processing-device;

FIG. 2 details the external-processing-device shown in FIG. 1, including system memory;

FIG. 3 shows the steps performed with the external-processing-device shown in FIG. 2, including a step of executing virtual environment instructions;

FIG. 4 details contents of the system memory shown in FIG. 2;

FIG. 5 details the step of executing virtual environment instructions shown in FIG. 3, including a step of executing input device driver instructions and a step of updating a virtual environment;

FIG. 6 details the step of executing input device driver instructions shown in FIG. 5, including steps of analysing acceleration-data, performing calibration gesture processing, rotating an orientation and deriving a locomotion-factor;

FIG. 7 details the step of analysing acceleration-data shown in FIG. 6;

FIG. 8 details the step of performing calibration gesture processing, shown in FIG. 6;

FIG. 9 details the step of rotating an orientation shown in FIG. 6;

FIG. 10 details the step of deriving a locomotion-factor shown in FIG. 6;

FIG. 11 details the step of updating a virtual environment shown in FIG. 5;

FIG. 12 details user manipulation of the input device shown in FIG. 1;

FIG. 13 shows the effect of the user manipulation of the input device shown in FIG. 1;

FIG. 14 shows an additional effect of the user manipulation of the input device shown in FIG. 1;

FIG. 15 shows the components of the receiver shown in FIG. 1;

FIG. 16 details operations performed by the receiver detailed in FIG. 15;

FIG. 17 shows the components of the input device shown in FIG. 1, including system memory;

FIG. 18 details physical construction of the input device shown in FIG. 1, including a hand-area-sensor;

FIG. 19 shows a schematic representation of the hand-area-sensor shown in FIG. 18;

FIG. 20 details an alternative embodiment of the hand-area-sensor of the kind shown in FIG. 18;

FIG. 21 shows the steps performed when using the input device shown in FIG. 1, including a step of executing device firmware instructions;

FIG. 22 shows the contents of system memory shown in FIG. 17;

FIG. 23 details the step of executing device firmware instructions shown in FIG. 21;

FIG. 24 summarises the operations performed by the system shown in FIG. 1; and

FIG. 25 illustrates an embodiment in which an input device is used to fly an aircraft.

### BRIEF DESCRIPTION OF EXAMPLE EMBODIMENTS

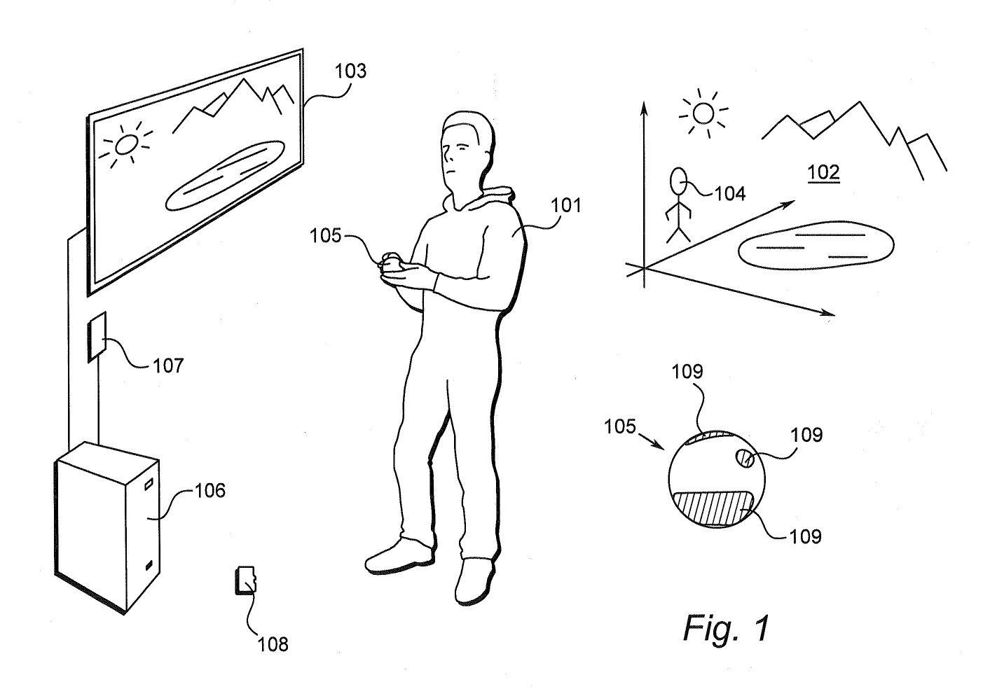

FIG. 1

A system for presenting immersive images to a user is shown in FIG. 1. A user 101 views a three-dimensional virtual environment 102 on a conventional two-dimensional display 103. The images shown to the user on the display 103 are generated using a mathematical projection of the virtual environment 102 from the location and angle of the users viewpoint 104 in the virtual environment 102. The user 101 moves through the virtual environment 102 using a hand-held substantially spherical input device 105. Gestures made with the input device 105 result in movement of the user's viewpoint 104, known as locomotion, and also changes in the angle of the viewpoint 104. The input device 105 enables movement and rotation of their viewpoint 104 in the virtual environment 102 to be achieved in a very intuitive and natural way.

The virtual environment 102 is a simulated three-dimensional environment constructed from data representing various objects, their appearance and physics properties. In an embodiment, the virtual environment 102 is a real environment at a remote location, or a mixture of simulated and real environments. This may include volumetric or visual three dimensional recordings made at remote locations that the user can navigate at a time of their choosing, as well as real time data that allows the user 101 to view or interact with remote people and events. In a further embodiment, the virtual environment is a three-sixty degree video or photograph in which the user 101 may adjust their viewpoint 104 by zooming, and/or vertically and/or horizontally panning using the input device 105. When navigating three-sixty video or photograph, the effect of moving forward or backwards in the virtual environment 102 is achieved by zooming in or out.

In an embodiment, the display 103 is a virtual reality (VR) headset that replaces the user's field of view with stereoscopic images supplied individually to each eye. However, it will be appreciated that an advantage of the system shown in FIG. 1, is that the user 101 has a sense of immersion without the need for a headset, and a conventional display can be used.

An external-processing-device 106 receives gestural-data from the input device 105 via a receiver 107, and renders the virtual environment 102. In an embodiment, the virtual environment 102 is rendered and displayed using a laptop computer, and the display 103 is part of the laptop computer. In a further embodiment, the receiver 107 is also part of the laptop computer. In a further embodiment, the receiver is part of a VR headset. In an embodiment, the external-processing-device 106 is part of a VR headset. However, an advantage of the preferred embodiment, is that the user 101 feels a sense of immersion without the need for a headset. This is due to the correspondence between gestures made with the input device 105 and resulting adjustments made to the user's viewpoint 104 shown on the display 103.

An SD Card 108 stores instructions for the external-processing-device 106 and the input device 105.

The input device 105 is hand-supported, resulting in a contact-area 109 between the user's hands and the input device 105. The contact-area 109 is the area of the user's hands that imparts a manual rotation to the input device 105. The purpose of the input device's spherical shape is to ensure that it feels substantially the same to the user 101, even after manual rotation. A sphere is the only shape that has this property.

The receiver 107 is oriented with respect to the user's sense of forwards. When the user 101 is viewing the virtual environment 102 on the display 103 it is natural for the user 101 to face the display 103. Thus, the receiver 107 may be aligned with the display 103, by mounting it on the wall in front of the display 103. As a result, the receiver 107 has an orientation with respect to the user 101, when the user 101 is navigating the virtual environment 102.

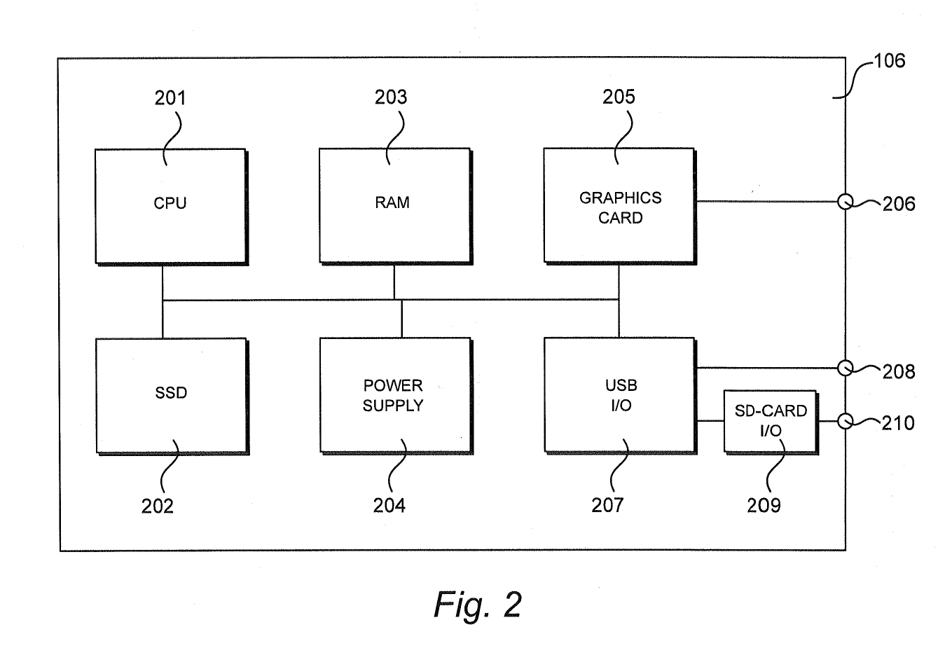

FIG. 2

Components of the external-processing-device 106 shown in FIG. 1 are shown in FIG. 2. A Central Processing Unit (CPU) 201 executes instructions and processes data from a Solid State Disk (SSD) 202, using dynamic Read-And-write Memory 203 for volatile caching and storage. A power supply 204 supplies regulated power to each of the components of the system 106. A graphics card 205 includes a Graphics Processing Unit (GPU) for optimised rendering of the virtual environment 102, and which generates image data supplied to the display 103 via a digital video connection 206. A Universal Serial Bus (USB) Input and Output (I/O) circuit 207 provides a connection to external devices via a USB connection 208, including a connection made with the receiver 107 shown in FIG. 1. An SD interface 209 provides connectivity for the SD card 108 shown in FIG. 1, via an SD socket 210.

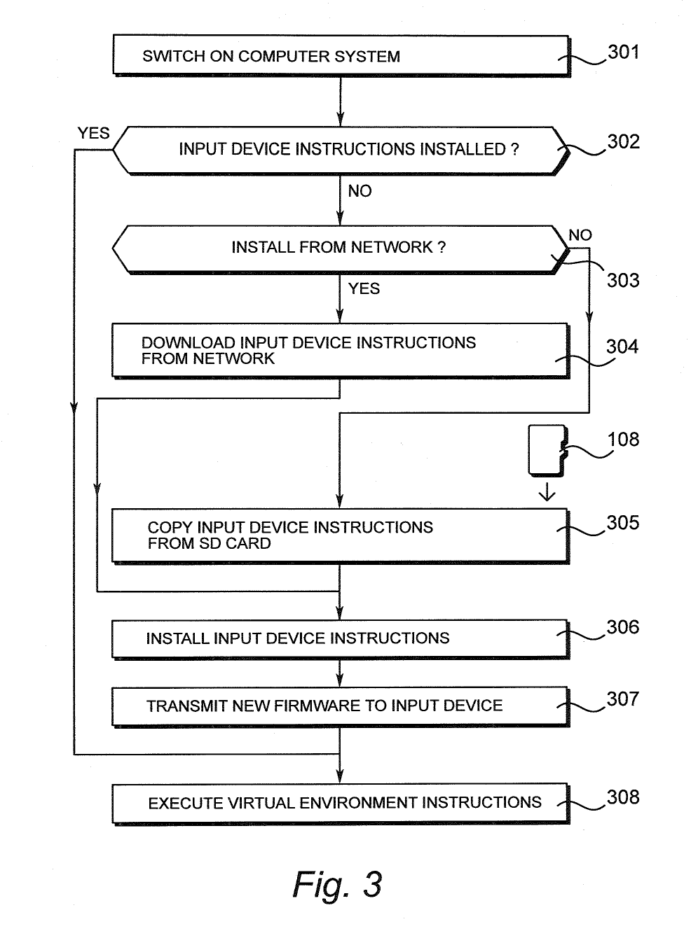

FIG. 3

Operation of the external-processing-device 106 detailed in FIG. 2 is shown in the flowchart of FIG. 3. At step 301 the external-processing-device 106 is switched on. At step 302 a question is asked as to whether instructions for the input device 105 have been installed. If not, control is directed to step 303, where a question is asked as to whether to install the instructions from a network, such as the Internet. Network download is performed at step 304. Alternatively, input device instructions are copied from the SD card 108 at step 305. At step 306 the instructions are decompressed, authenticated and installed to the SSD 202. At step 307, firmware installed on the SSD 202 is transmitted wirelessly to the input device 105. At step 308, virtual environment instructions are executed.

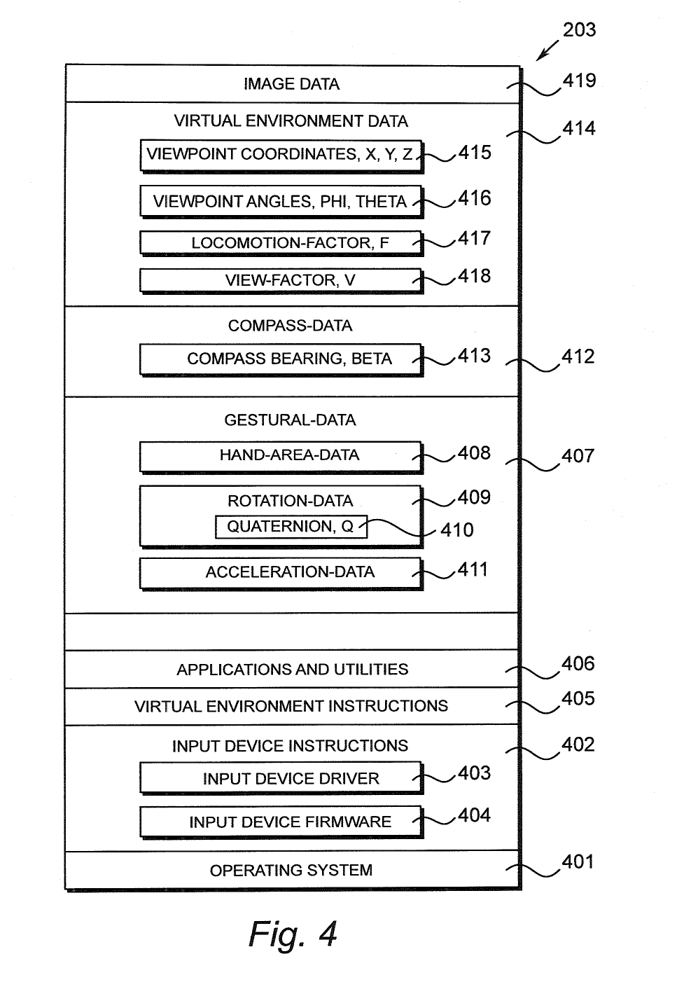

FIG. 4

As a result of the steps shown in FIG. 3, the contents of the processing system's RAM 203 shown in FIG. 2 are as shown in FIG. 4. An operating system 401 provides hardware abstraction and processing management. Input device instructions 402, installed at step 306 in FIG. 3, include an input device driver 403, which provides instructions executed by the CPU 201 for obtaining gestural-data from the input device 105 and installing firmware on the input device 105. Also included in the input device instructions is input device firmware 404, that was transmitted to the input device 105 at step 307. Additionally present in RAM 203 are virtual environment instructions 405 and instructions for other applications and utilities 406.

Data in RAM 203 includes gestural-data 407 received from the input device 105. Gestural-data 407 includes hand-area-data 408, which provides an indication of the contact-area 109. Gestural-data 407 further includes rotation-data 409, that describes the orientation of the input device 105 using a quaternion, Q, 410. A quaternion is a vector of four components, defining orientation angles about perpendicular x-, y- and z-axes using three imaginary components i, j and k, plus a real magnitude, w. The quaternion 410 is updated at two hundred times a second, so a manual rotation of the input device 105 results in changing values of the components of the quaternion 410. Gestural-data 407 also includes acceleration-data 411, which has x, y and z components and is used to identify non-rotational gestures made with the input device 105, such as gestures that include tapping on its surface.

Data contents of RAM 203 also include compass-data 412. The compass-data 203 includes a geomagnetic compass bearing, BETA, 413, which defines the forward-facing direction of the user 101 in terms of the Earth's geomagnetic field.

Data in RAM 203 further includes virtual environment data 414. This includes all object data, physics data, bitmaps and so on that are used to define a virtual environment. Virtual environment data 414 also includes location coordinates 415 of the user's viewpoint 104, and viewpoint angles 416. The first of the viewpoint angles 416 is PHI, and describes the rotation of the viewpoint 104 about a vertical axis in the virtual environment 102. The second of the viewpoint angles 416 is THETA, which describes whether the user is looking up or down in the virtual environment 102. THETA defines the rotation of the viewpoint 104 about a horizontal x-axis in the virtual environment 102, that extends through the viewpoint 104, from left to right. Virtual environment data 414 also includes a locomotion-factor, F, 417 and a view-factor, V, 418.

Also in RAM 203 is image data 419, that is generated as the result of rendering the virtual environment data 414. Image data 419, and other data, may be held in memory in the graphics card 205, but is shown in the main memory of FIG. 4, for the purposes of clarity.

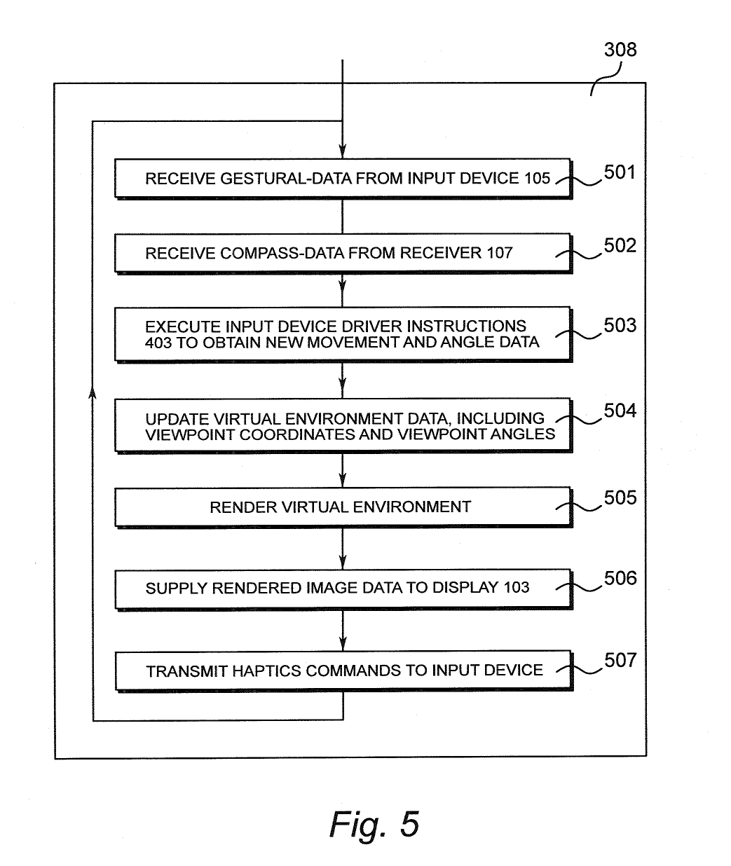

FIG. 5

The step 308 of running virtual environment instructions 405 is detailed in FIG. 5. At step 501, gestural-data 407 is received by the CPU 201 from the input device 105, via the receiver 107 and the USB connection 208. Gestural-data 407 received from the input device 105 includes hand-area-data 408, rotation-data 409 and acceleration-data 411. At step 502, the external-processing-device 106 receives compass-data 412 from the receiver 107, which the receiver 107 generates in response to its physical orientation in the Earth's geomagnetic field. The receiver's compass-data 412 also describes the user's orientation in the Earth's geomagnetic field, because the user 101 is facing the receiver 107, which has been placed directly beneath the display 103.

At step 503, the input device driver instructions 403 are executed to obtain new movement and angle data from the gestural-data 407 and compass-data 412. At step 504, virtual environment data 414 is updated, including the coordinates 415 and angles 416 of the viewpoint 104. At step 505, the virtual environment 102 is rendered to generate image data 419.

At step 506, the rendered image data 419 is supplied to the display 103. The receiver 107 is also capable of transmitting data to the input device 105 when necessary. At step 507, haptics commands are transmitted to the input device 105, via the receiver 107. Haptics commands cause the input device 105 to vibrate, providing physical feedback to the user 101.

After completion of step 507, control is directed back to step 501. The steps of FIG. 5 are repeated at a rate of two hundred times per second, resulting in a rapid sequence of images, perceived by the user 101 as continuous movement as they navigate through the virtual environment 102.

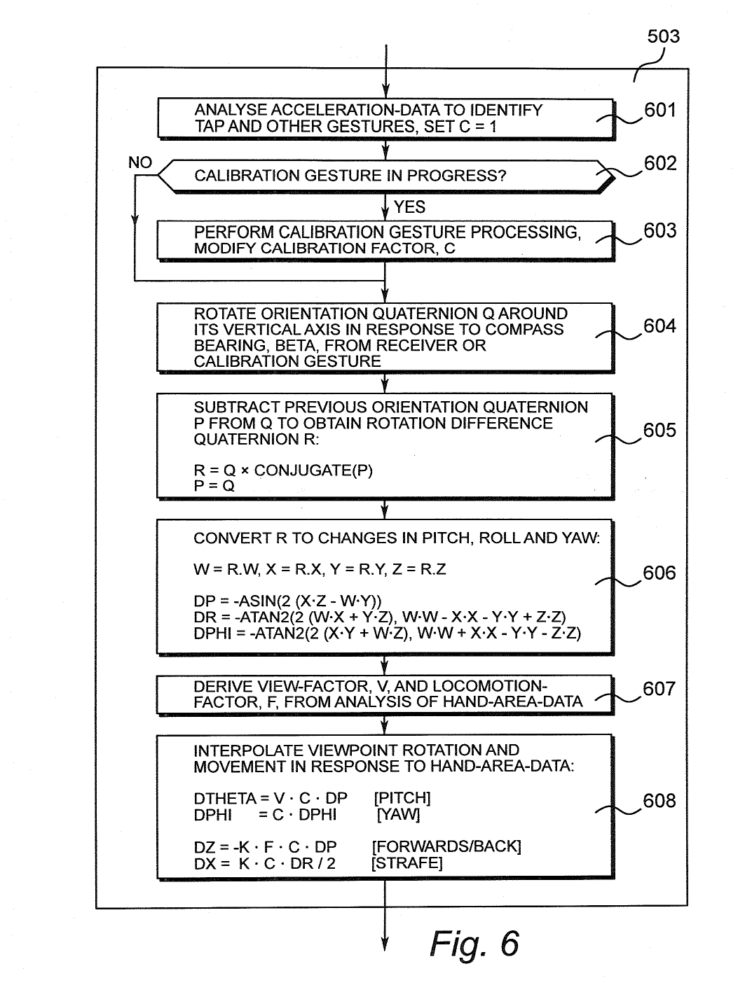

FIG. 6

The step 503 of executing input device driver instructions, shown in FIG. 5, is detailed in FIG. 6. At step 601, acceleration-data 411 is analysed to identify when the user 101 has tapped the surface of the input device 105 and to identify when a calibration gesture is being made with the input device 105. Also, at step 601, a calibration factor, C, is set to an initial value of one. At step 602, a question is asked as to whether a calibration gesture is in progress. If not, control is directed to step 604. Alternatively, at step 603, calibration gesture processing is performed, including modifying the calibration factor, C.

The orientation quaternion, Q, 410, is part of the rotation-data 409 received in the gestural-data 407 at step 502. At step 604, the orientation quaternion, Q 410 is rotated around its vertical axis in response to the compass bearing, beta, 413. The purpose of this is to interpret user gestures, including forward locomotion gestures, with respect to the user's orientation with respect to the display 103. In other words, when the user 101 rolls the input device 105 forwards towards the display 103, the user perceives a forward movement of their viewpoint 104 in the virtual environment 102 as it is shown on the display 103.

At step 605, a previous orientation quaternion, P, is subtracted from Q, 410, to obtain a rotation difference quaternion, R. After R has been calculated, the value of Q is copied into P in preparation for the next loop. A distinction is made between a rotation, which is a circular movement, and an orientation, which can be a static condition. The orientation quaternion, Q, 410, represents the static condition of the input device at the moment in time when its orientation is measured. The rotation quaternion, R, represents the change in orientation that has occurred over the previous five milliseconds.

At step 606, the rotation, R, is converted into changes in pitch, roll, and yaw, represented by DP, DR and DPHI respectively. DP is the change in pitch, which is a forward rotation of the input device 105 about an x-axis with respect to the user's forwards direction. DR is the change in roll, which is a lateral roll of the input device 105 about a forward-facing z-axis with respect to the user's sense of direction. DPHI is the change in yaw, which is a rotation of the input device 105 about a vertical y-axis.

At step 607, the locomotion-factor, F, 417 and the view-factor, V, 418 are derived from an analysis of the hand-area-data 408.

At step 608, the viewpoint rotation and movement are interpolated in response to the values of F and V calculated at step 607 in response to the hand-area-data 408. This results in updates of variables DTHETA, DPHI, DZ and DX. DTHETA is the change in the up and down pitch-angle of the viewpoint 104 about an x-axis with respect to the user's orientation in the virtual environment 102. DPHI is the change in a yaw-angle of the viewpoint 104 about a vertical y-axis in the virtual environment 102. Together, DTHETA and DPHI completely define the angle of the user's viewpoint 104 in the virtual environment 102. DTHETA is affected by the view-factor, V, 418, such that angular up and down rotations of the viewpoint 104 only occur when the user 101 is manipulating the input device 105 with a large contact-area 109. A large contact-area 109 can be obtained by supporting the device within the palms of both hands. When the contact-area 109 is small, for example when the user manipulates the input device 105 only using their fingertips, the view-factor, V, is low, and the same rotation of the input device results in locomotion. DZ defines forwards and backwards movement of the viewpoint 104 with respect to the user's orientation in the virtual environment 102, and is affected by the locomotion-factor, F, 417, which has an inverse relation to the view-factor 418. DX defines side-to-side movement of the viewpoint 104, also known as strafing. DX is not affected by the view-factor, F.

The calculations performed in step 608 also depend on the calibration factor, C, and a locomotion scaling constant, K. The calibration factor C changes from zero to one over a short time during the calibration gesture identified at step 602. The locomotion scaling constant defines the number of meters moved per degree of rotation, and may be set differently for different kinds of virtual environment.

The result of the calculations performed at step 608, is that the user 101 can easily and naturally move around the virtual environment 102, by rotating the input device. Forward movement is obtained by rotating the input device 105 forwards. The direction of movement can be changed by rotating the input device 105 about its vertical axis. Sideways, strafing movement can be obtained by rotating the device about its forward-facing axis. The user can change the up and down angle of the viewpoint 104 by holding the device in the palms of the hands, resulting in an increased contact-area 109, and then rotating the device forwards or backwards.

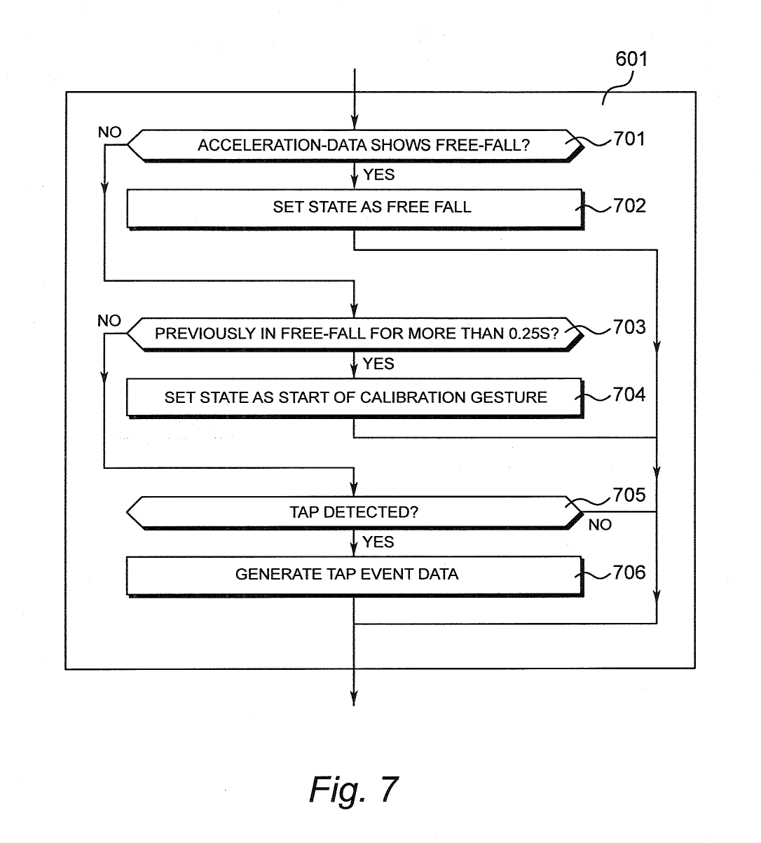

FIG. 7

The step 601 of analysing acceleration-data 411, shown in FIG. 6, is detailed in FIG. 7. at step 701, a question is asked as to whether the acceleration-data 411 shows that the input device 105 is in free-fall. Free-fall is indicated by all three axes of x, y and z acceleration-data 411 having a near-zero value for more than a quarter of a second. If the input-device 105 is in free-fall, control is directed to step 702, where a state is set to indicate the free-fall condition. If not in free-fall, control is directed to step 703, where a question is asked as to whether the device was previously in a free-fall state for more than a quarter of a second. If so, control is directed to step 704, where the state is set as being the start of a calibration gesture. Alternatively, control is directed to step 705, where a question is asked as to whether a tap event has been detected. If so, control is directed to step 706, where tap event data is generated.

The steps of FIG. 7 have the effect of detecting two kinds of non-locomotion gesture. The first kind of gesture detected is a tap gesture, in which the user 101 taps the surface of the input device 105 with their fingers. This is used to trigger events that would otherwise be performed using a mouse click. The second kind of gesture is a calibration gesture. The calibration gesture is in two parts. The first part is a calibration initiation gesture, in which the user 101 throws the input device 105 briefly upwards, and then catches it. This generates the free-fall condition detected at step 701. The second part of the calibration gesture is continuation of the calibration gesture, in which the user subsequently continuously rotates the input device 105 forwards, defining the direction that the user 101 considers to be forwards. This calibrated direction is then be used to replace the compass-data 412 that is otherwise provided by the receiver 107.

The purpose of the calibration gesture is to ensure the accuracy of the compass-data 412. The first-magnetometer 1508, located in the receiver 107, may be subject to magnetic fields from loudspeakers or other sources, reducing its accuracy. Having obtained approximate compass-data 412 from the receiver 107, the user may improve the accuracy of the compass-data 412 by performing the calibration gesture described. In the presence of a large distorting magnetic field, the receiver's magnetometer data may not be usable, in which case the calibration gesture provides the only reliable way of defining the user's forward-facing direction.

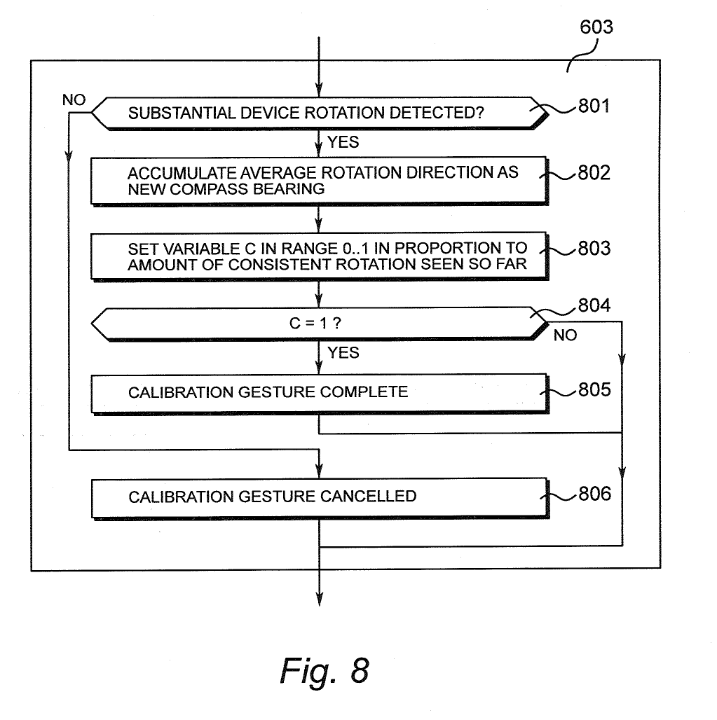

FIG. 8

The step 603 of performing calibration gesture processing, shown in FIG. 6, is detailed in FIG. 8. These steps are only performed after completion of the first part of the calibration gesture. The first part is free-fall, the second part is rotation.

At step 801, a question is asked as to whether a substantial device rotation has been detected, by analysing the rotation-data 409, including the orientation quaternion 410. If rotation has been detected, control is directed to step 802, where the average rotation direction is accumulated as a new compass bearing 413. At step 803, the calibration factor, C, is set to a value in proportion to the amount of consistent rotation since the start of the second part of the calibration gesture. C takes a value in the range zero to one, and is gradually increases to reintroduce locomotion at step 608 in FIG. 6. This reintroduction lasts around a second or so, depending on the consistency of the direction of rotation during the second stage of the calibration gesture.

At step 804, a question is asked as to whether the calibration factor, C, has reached its maximum value of one. If so, the calibration gesture state is set as complete at step 805. If no significant device rotation was detected at step 801, control is directed to step 806, where the calibration gesture is cancelled.

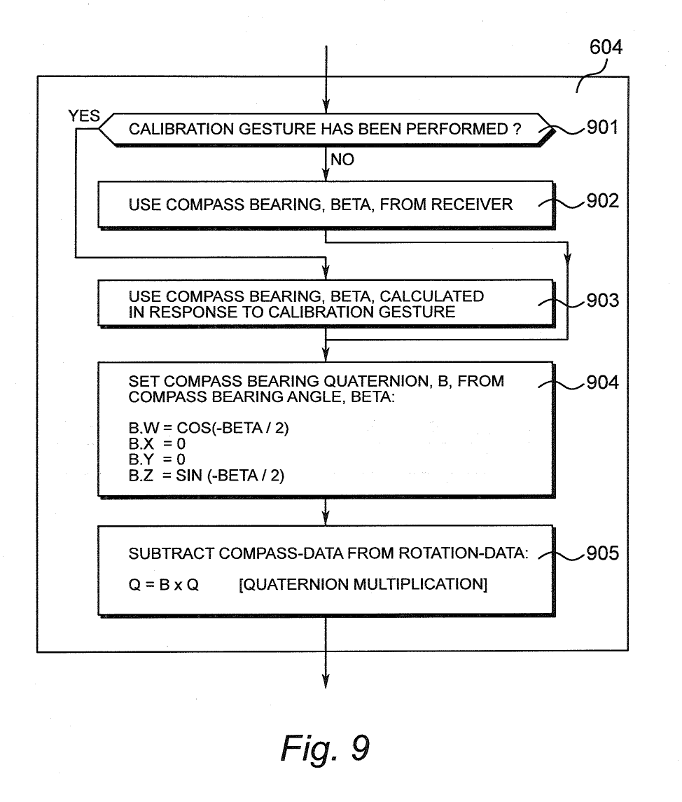

FIG. 9

The step 604 of rotating the orientation quaternion 410, shown in FIG. 6, is detailed in FIG. 9. At step 901, a question is asked as to whether a calibration gesture has been performed. If not, at step 902 the compass bearing, beta, 413 is left unchanged, taking the value obtained from the receiver 107 at step 502 in FIG. 5. Alternatively, at step 903, the compass bearing calculated at step 802 in FIG. 8 is used, which is derived from the calibration gesture.

At step 904, a compass bearing quaternion, B, is updated from the compass bearing angle, BETA, 413. At step 905, the compass-data 412 is subtracted from the rotation-data 409. This is implemented by multiplying the compass bearing quaternion, B, by the orientation quaternion, Q, 410, and updating Q, 410 with the result. This removes the Earth's geomagnetic field from the orientation, Q, so that any rotations about the vertical axis of the input device are then measured with respect to the user's forwards direction. This process of establishing the frame of reference for user gestures, with respect to the user's subjective awareness, may also be referred to as normalisation.

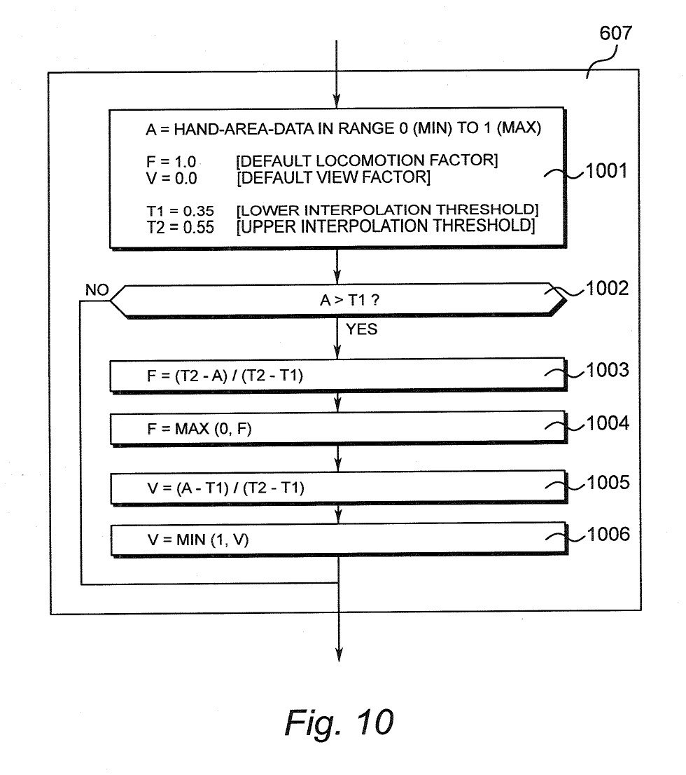

FIG. 10

The step 607 of deriving the view-factor, V, and locomotion-factor, F, shown in FIG. 6, is detailed in FIG. 10. At step 1001, a variable A is set from the hand-area-data 408, which takes values in the range zero to one. This range represents a contact-area 109 from zero to the maximum area of the input device's surface that can be enclosed between the user's hands. Also in step 1001, the locomotion-factor 417 is initialised to a value of one, and the view-factor 418 is initialised to a value of zero. Two constants are defined, T1 and T2, that establish an interpolation range. T1 represents a lower contact-area threshold, below which F and V are unaffected. T2 represents a higher contact-area threshold, above which F and V are set to zero and one respectively. The intermediate range between T1 and T2 is where F and V are interpolated.

At step 1002, a question is asked as to whether A is greater than T1. If not, F and V are not modified, and no further calculation is required. Alternatively, if the T1 threshold is exceeded, steps 1003 to 1006 are performed. At step 1003, F is interpolated to a value between one and zero, in response to the value of A. At step 1004, the calculation of F is completed by limiting its lowest value to zero. At step 1005, V is interpolated to a value between zero and one, in response to the value of A. At step 1006, the calculation of V is completed by limiting its highest value to one. In these calculations, F and V change inversely with respect to each other. As A increases from T1 to T2, F decreases from one to zero, and V increases from zero to one.

The effect of the steps of FIG. 10 is to interpolate between two different ways of interpreting a forward rotation gesture of the input device 105. If the input device 105 is manipulated primarily by the user's fingertips, the contact-area 109 is small, and the hand-area-data 408 usually takes a value below T1. The locomotion-factor, F, 417 is then set to one, and the calculations performed at step 608 in FIG. 6, cause a change in DZ, which affects the location of the user's viewpoint 104. Conversely, if the input device 105 is manipulated while supported in the user's palms, the contact-area 109 is large, and the hand-area-data 408 takes a value larger than T2. The locomotion-factor, F, 417 is then set to zero, the view-factor, V, 418, is set to one, and the calculations performed at step 608 in FIG. 6, cause a change in DTHETA, which then affects the up and down angle of the user's viewpoint 104.

If only a single threshold were used to switch between these two kinds of rotation gesture, the abrupt transition between two different modes would be disorienting for the user. Instead, two thresholds are interpolated, enabling the user 101 to automatically adjust to the transition between locomotion and up and down view rotation, thereby facilitating smooth navigation of the virtual environment 102.

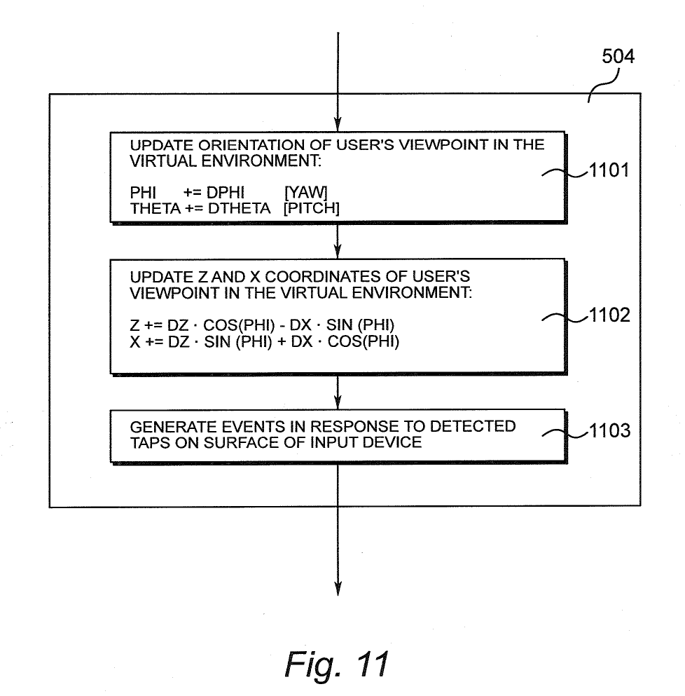

FIG. 11

Having established the change in viewpoint location and angle, these are applied to the virtual environment 102 in step 504, shown in FIG. 5. Step 504 is detailed in FIG. 11.

At step 1101 the orientation of of the user's viewpoint 104 is updated, as defined by the two angular changes DPHI and DTHETA, calculated at step 608 in FIG. 6. DPHI represents a yaw-rotation about a vertical y-axis in the virtual environment 102, and is added to PHI, which is the yaw-angle of the viewpoint 104. DTHETA represents a pitch-rotation about a horizontal x-axis in the virtual environment, from the user's viewpoint 104, and is added to THETA, which is the pitch-angle of the viewpoint 104. Thus, a viewpoint angle 416 is adjusted in response to the rotation-data 409 with the hand-area-data 408.

At step 1102, the z and x absolute coordinates of the viewpoint 104 are updated in response to gestural-data 407 and via the calculations performed as described above. At step 1103, additional virtual environment events are generated in response to tap event data generated at step 706.

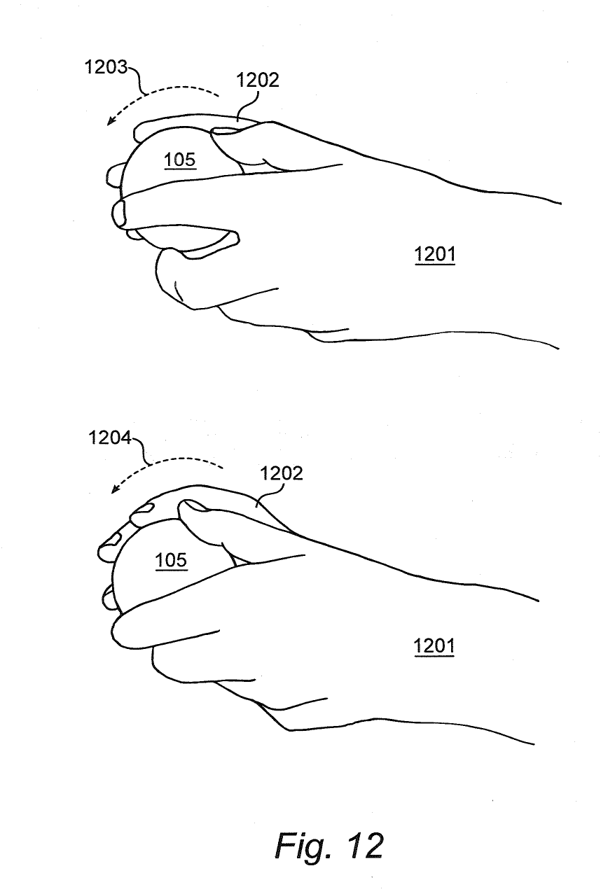

FIG. 12

Manipulation of the input device 105 shown in FIG. 1 is detailed in FIG. 12. The input device 105 is supported by the left hand 1201 and right hand 1202 of the user 101. Continuous rotation of the input device 105 is achieved by a first rotation 1203 performed by the left hand 1201 followed by a second rotation 1203 performed by the right hand 1202. When the input device is supported and manipulated primarily by the fingertips, forward rotation 1203, 1204 of the input device 105 results in a corresponding forward movement, of the location of the viewpoint 104 in the virtual environment 102. If the input device 105 is supported and manipulated with a larger contact-area 109, forward rotation 1203, 1204 of the input device 105 results in a corresponding forward rotation of the user's viewpoint 104 in the virtual environment 102.

The input device 105 has a high sensitivity to rotation 1203, 1204, and even a small rotation results in some degree of movement of the user's viewpoint 104. This results in a sense of immersion for the user 101, even though the virtual environment 102 is displayed to the user 101 on a conventional display 103.

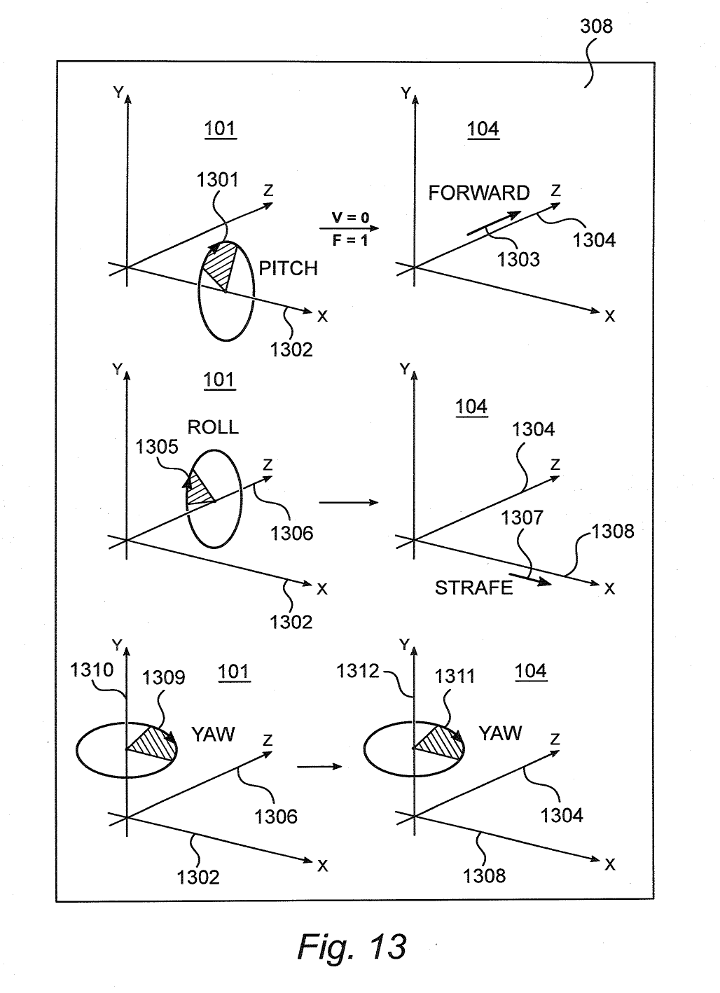

FIG. 13

Adjustment of the viewpoint 104 in response to rotation of the input device 105 during a low contact-area 109 is summarised in FIG. 13. A forward pitch-rotation 1301 of the input device 105 about an x-axis 1302 in the frame of reference of the user 101 is made. A low contact-area 109 due to fingertip manipulation of the input device 105, results in a hand-area-data 408 value of less than T1, giving a locomotion-factor, F, 417 of one, and a view-factor, V, 418, of zero. Therefore, in accordance with the calculation defined at step 608 in FIG. 6, the forward rotation 1301 results in forward movement 1303 of the viewpoint 104 along a z-axis 1304, relative to the viewpoint 104 in the virtual environment 102. Note that the z-axis 1304 is usually not the global z-axis of the virtual environment 102, but a z-axis relative to the orientation of the viewpoint 104.

In an embodiment, the movement of the location of the viewpoint is implemented by zooming in on an image. This makes it possible to move around the virtual environment 102 even when it is generated from a panoramic image or three-sixty video, such as that provided by a three-sixty camera or multiple images stitched together. Usually, the forward rotation 1301 causes a change in the position of the viewpoint 104. In an embodiment, the forward rotation 1301 causes a change in the velocity of movement of the viewpoint 104. Whichever method is used, the pitch rotation 1301 of the input device 105 causes a forward movement 1303 of the viewpoint 104 along the z-axis 1304.

A roll-rotation 1305 of the input device 105 about a z-axis 1306 in the frame of reference of the user 101, results in strafing movement 1307 of the viewpoint 104 along an x-axis 1308, relative to the viewpoint 104 in the virtual environment 102. Strafing 1307 is not affected by the contact-area 109. Strafing movement 1307 may be referred to as a translation of the viewpoint's coordinates 415. More generally, movement of an object's coordinates in a three-dimensional environment is referred to as translation.

A yaw-rotation 1309 of the input device 105 about a vertical y-axis 1310 in the frame of reference of the user 101, results in a corresponding yaw-rotation 1311 of the viewpoint 104 about a vertical y-axis 1312, relative to the viewpoint 104, in the virtual environment 102. As with strafing, yaw-rotation 1311 is not affected by the contact-area 109.

The user 101 naturally combines all three rotations 1301, 1305, 1309 when moving through the virtual environment 104. Usually one rotation of the three will be much larger than the others, but the other small rotations combine to provide the sense of immersion in the virtual environment 102. It will be understood that the device rotation 1310 will result in rotation of the z-axis 1304 and the x-axis 1308 in the global coordinate system of the virtual environment 102.

Rotations of the input device 105 are shown in FIG. 13 with a positive polarity. It will be appreciated that reversing this polarity results in a corresponding reverse effect. For example, if forward rotation 1301 is reversed, the forward movement 1303 is also reversed, resulting in a backwards movement of the location of the viewpoint 104.

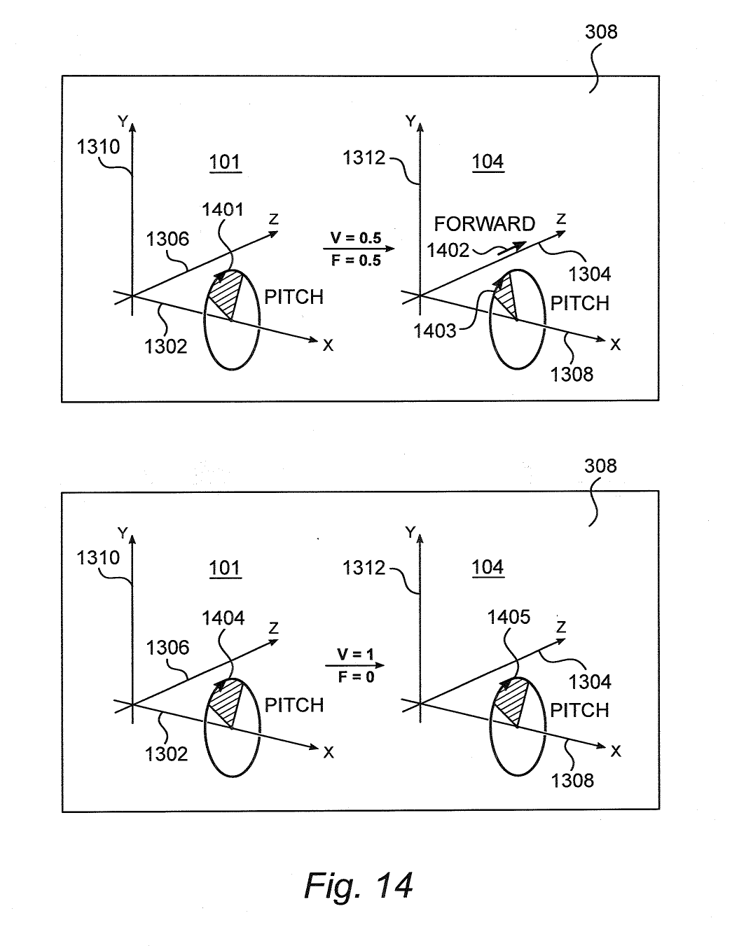

FIG. 14

Interpolated adjustment of the viewpoint 104 in response to rotation of the input device 105 is detailed in FIG. 14. A forward pitch-rotation 1401 of the input device 105 about the x-axis 1302 is made. A medium-sized contact-area 109 due to fingertip and palm manipulation of the input device 105, results in a hand-area-data 408 value half way between T1 and T2, giving a locomotion-factor, F, 417 of one half, and a view-factor, V, 418, of one half. Therefore, in accordance with the calculation defined at step 608 in FIG. 6, the forward rotation 1401 results in a mixture of forward movement 1402 of the viewpoint 104 along the viewpoint's z-axis 1304 and a pitch-rotation 1403 of the viewpoint 104 around the viewpoint's x-axis 1308. It will be appreciated that the viewpoint rotation 1403 is half that of the input device's rotation 1401, due to the nature of the interpolation calculated at step 608. Furthermore, the viewpoint movement 1402 is reduced by half, compared to that shown in FIG. 13 at 1303. Under these conditions, the device rotation 1401 will result in rotation of the viewpoint's z-axis 1304 and y-axis 1312 in the global coordinate system of the virtual environment 102.

When sufficient contact-area 109 exists between the user's hands 1201, 1202 and the input device 105, the hand-area-data 408 exceeds T2, giving a locomotion-factor, F, 417 of zero, and a view-factor, V, 418, of one. This condition can be achieved by manipulating the device within the palms of both hands, or with all fingers of both hands in contact with the surface of the input device 105.

Under this condition, a forward pitch rotation 1404 of the input device 105 about its x-axis 1302 gives no locomotion. The input device rotation 1404 is entirely converted into a pitch rotation 1405 of the viewpoint 104 around the viewpoint's x-axis 1308.

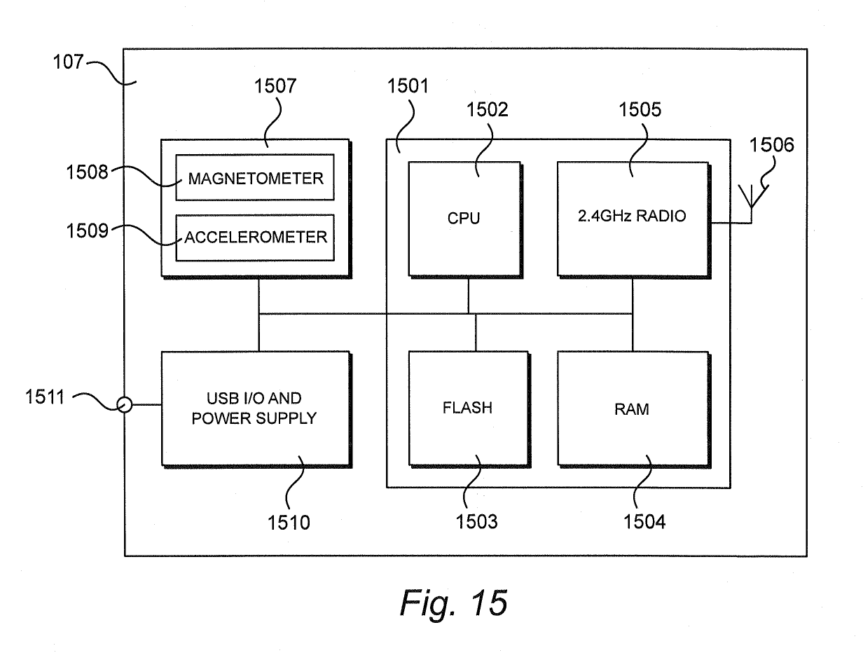

FIG. 15

The receiver 107 shown in FIG. 1, is detailed in FIG. 15. The receiver includes an nRF52832 System on Chip (SOC) 1501. The SOC 1501 includes a 32-bit ARM™ Cortex™ Central Processing Unit (CPU) 1502 with 512 KB of FLASH memory 1502 and 64 KB of RAM 1503. The SOC 1501 also includes a 2.4 GHz radio transceiver 1505. The nRF52832 is available from Nordic Semiconductor, Nordic Semiconductor ASA, P.O. Box 436, Skøyen, 0213 Oslo, Norway. The radio 1505 is configured primarily as a receiver. However, it is also able to transmit acknowledgement and data in response packets transmitted to the input device 105. In an embodiment, the radio 1505 is configured to operate according to a low power Bluetooth™ 5.0 protocol in order to operate with an input device 105 compatible with that protocol. An antenna 1506 receives or transmits radio waves at the carrier frequency of 2.4 GHz.

Other components in the receiver 107 include an MPU-9250 inertial-measurement-unit (IMU) 1507 that includes a three-axis-first-magnetometer 1508 and a three-axis-accelerometer 1509. The MPU-9250 also includes a three-axis-gyroscope, which is not used by the receiver 107. The MPU-9250 is available from InvenSense Inc., 1745 Technology Drive, San Jose, Calif. 95110, U.S.A. The receiver 107 further includes a USB 110 an power supply circuit 1510, which provides an interface to the external-processing-device 106 via a USB connector 1511. Power for the receiver 107 is obtained from the connector 1511.

In an embodiment, the receiver components shown in FIG. 15 are contained within a VR headset.

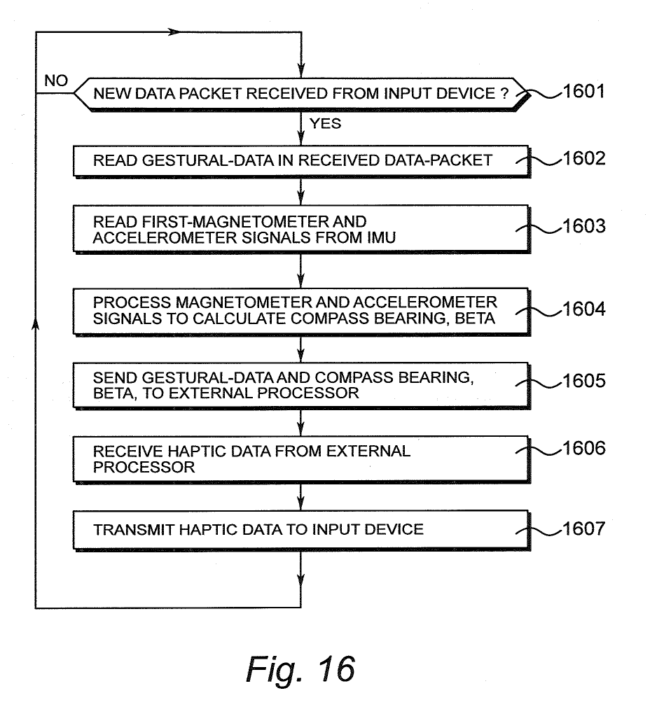

FIG. 16

Instructions held in the FLASH memory 1503 of the receiver's SOC 1501 shown in FIG. 15 result in the SOC CPU 1502 performing the steps shown in FIG. 16. At step 1601, the CPU 1502 waits for the radio 1505 to receive the next data packet from the input device 105. At step 1602, gestural-data 407 is obtained from the received data packet. At step 1603, signals are obtained from the first-magnetometer 1508 and accelerometer 1509 in the IMU 1507. At step 1604 the first-magnetometer and accelerometer signals are processed to produce a compass bearing describing the orientation of the receiver 107 in the Earth's geomagnetic field. The accelerometer 1509 is used to perform tilt compensation for the first-magnetometer 1508 so the resulting compass bearing is not affected by the tilt of the receiver 107. A suitable algorithm is described in Application Note AN4248 available from https://cache.freescale.com/files/sensors/doc/app note/AN4248.pdf.

At step 1605 the gestural-data and receiver compass bearing are sent to the external-processing-device 106 via the USB connection 1511. At step 1606 any haptic data is received from the external-processing-device 106, and at step 1607 the haptic data is transmitted to the input device 105.

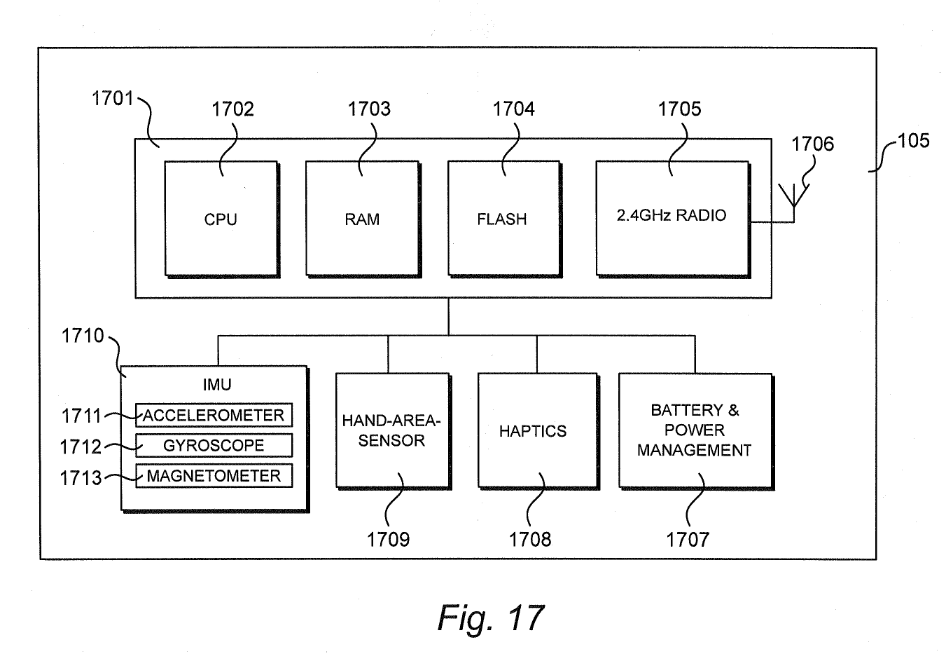

FIG. 17

The input device 105 shown in FIG. 1 is detailed in FIG. 17. An nRF52832 System on Chip (SOC) 1701 includes a 32-bit ARM™ Cortex™ device-processor (CPU) 1702 with 64 KB of RAM 1703 and 512 KB of FLASH 1704. The SOC 1701 includes a 2.4 GHz radio transceiver 1705, that is configured to send and receive packets of data to and from the receiver 107. The input device's radio 1705 is configured primarily as a transmitter. However, it is also able to receive acknowledgement signals and data in response packets transmitted from the receiver 107. An antenna 1706 transmits or receives radio waves at the carrier frequency of 2.4 GHz. In an embodiment, the radio 1705 is configured to operate according to a low power Bluetooth™ 5.0 protocol in order to operate with a receiver compatible with that protocol.

Other components of the input device 105 include a battery and power management circuit 1707 and a haptics peripheral 1708, that can be activated to vibrate the input device 105. A hand-area-sensor 1709 detects the contact-area 109 between the user's hands 1201, 1202 and the surface of the input device 105. A rotation-detector 1710 is provided by an MPU-9250 inertial-measurement-unit (IMU). The rotation-detector 1710 includes a three-axis-accelerometer 1711, a three-axis-gyroscope 1712 and a three-axis-second-magnetometer 1713. The accelerometer 1711 and gyroscope 1712 are each configured to generate new x-, y- and z-axis signal data at a rate of two hundred samples a second. The second-magnetometer generates new x-, y- and z-axis signal data at one hundred samples per second. The magnetometer samples are repeated in order to match the sample rate of the accelerometer 1711 and gyroscope 1712. The rotation-detector 1710 includes several sensors 1711, 1712, 1713 that track the orientation of the input device 105. As the user 101 rotates the input device 101, the change in orientation is converted into a rotation at step 605 shown in FIG. 6. The rotation-detector 1710 supplies accelerometer, gyroscope and magnetometer data to the device-processor 1702, which then regularly calculates an orientation.

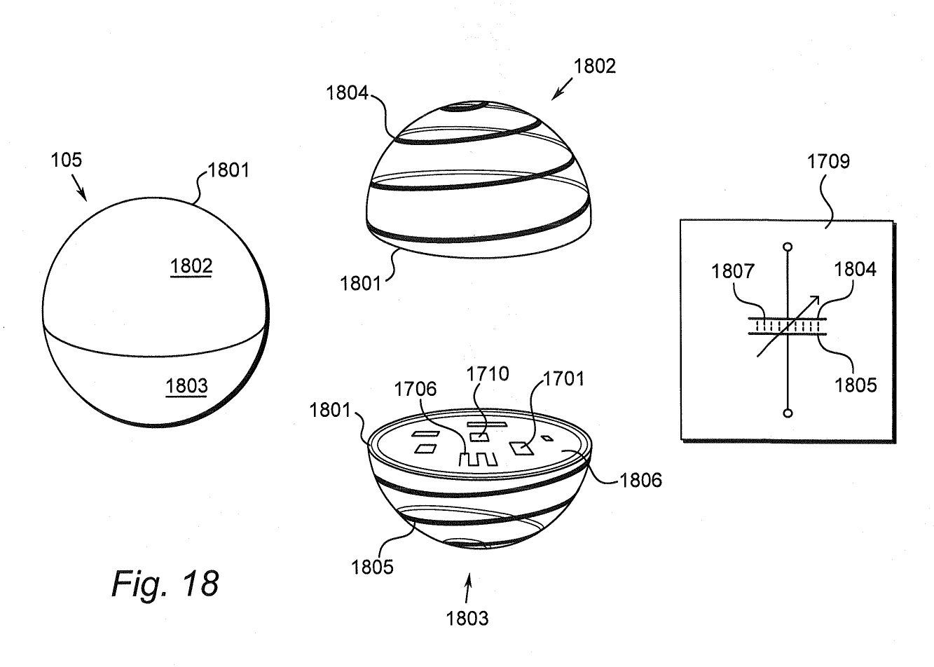

FIG. 18

Physical construction details of the input device 105 shown in FIG. 17 are detailed in FIG. 18. The input device 105 has an outer-surface 1801 that contains the components of FIG. 17. The outer-surface 1801 includes a first-hemisphere 1802 and a second-hemisphere 1803. The first-hemisphere 1802 provides a first-area of the outer-surface 1801, and includes a first spiral capacitive electrode 1804. The second-hemisphere 1802 provides a second-area of the outer-surface 1801, and includes a second spiral capacitive electrode 1805. The electrodes 1804, 1805 are formed by a spiral conductive foil strip on the inside of the outer-surface 1801 of the input device 105. The outer-surface 1801 is made from plastic, and provides electrical insulation for the electrodes 1804, 1805. A printed circuit board (PCB) 1806 is mounted approximately at the interface between the first-hemisphere 1802 and the second-hemisphere 1803. The PCB 1806 is slightly offset from the bisector of the input device 105, in order to compensate for the mass of the battery 1707 and ensure that the center of mass of the input device 105 is located at the center. Also, the slight offset locates the rotation-detector 1710 exactly at the center of the input device 105.

The first-hemisphere 1802 and the second-hemisphere 1803 provide an area-indicating-capacitance 1807 formed by the electrode 1804 of the first-hemisphere 1802 and the electrode 1805 of the second hemisphere 1803. The area-indicating-capacitance 1807 depends on the contact-area 109 of the user's hands in close proximity to the two electrodes 1804 and 1805. Counter-intuitively, the area-indicating-capacitance 1807 provides a good indication of the overall contact-area 109, even when the input device 105 has been rotated by an arbitrary amount.

It will be appreciated that the first-hemisphere 1802 and second-hemisphere 1803 cannot be covered in a conventional capacitive multitouch sensor, because the grid of wires required to implement such a sensor would make radio communication from the input device 105 impossible. Also included in the physical construction of the input device 105 is an inductive charging coil for charging the battery 1707 inductively. This has been omitted from FIG. 18 for the sake of clarity.

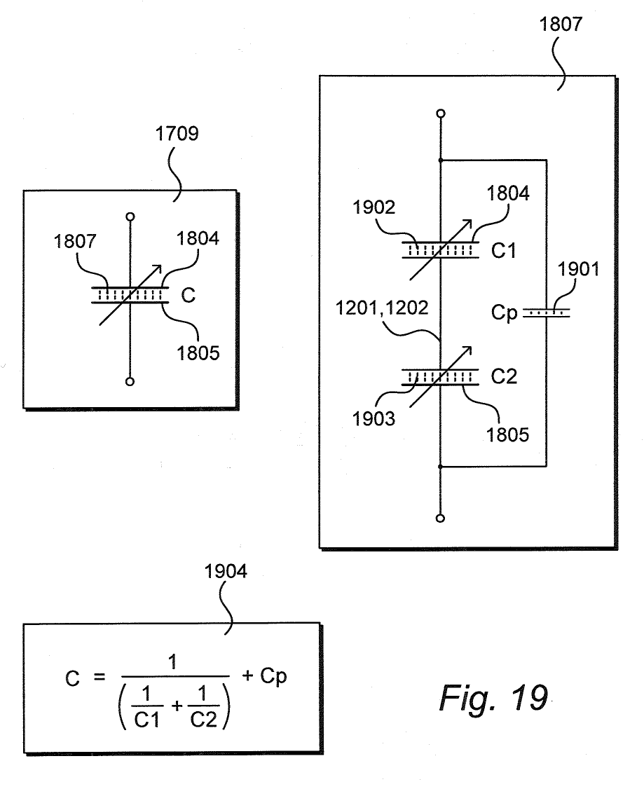

FIG. 19

The area-indicating-capacitance 1807 shown in FIG. 18 is detailed in FIG. 19. The capacitance, C, of the area-indicating-capacitance 1807, varies between about seventeen picofarads and twenty picofarads, depending on the contact-area 109. The area-indicating-capacitance 1807 includes a relatively large fixed parasitic capacitance, Cp, 1901, of about seventeen picofarads, which is due to the capacitance between conductive areas on the PCB 1806. The variable part of the area-indicating-capacitance 1807 is formed by a series connection between a first variable capacitance, C1, 1902 and a second variable capacitance, C2, 1903. The first variable capacitance 1902 is formed between the first capacitive electrode 1804 and the user's hands 1201, 1202. The second variable capacitance 1903 is formed between the user's hands 1201, 1202 and the second capacitive electrode 1805. The capacitance, C, of the area-indicating-capacitance 1807, is given by the capacitance equation shown at 1904.

The hand-area-sensor 1709 gives similar output regardless of the orientation of the input device 105. Its immunity to rotation may be understood in the following way. In any orientation of the input device 105, it is natural for the user 101 to manually rotate the input device 105 with a significant contact-area 109 of fingertips or palms on the first-hemisphere 1802 and the second-hemisphere 1803. In an uneven distribution of the same contact-area 109, the first variable capacitance 1902 is increased, and the second variable capacitance 1903 is correspondingly decreased. Although the value of C, given by the capacitance equation 1904, changes somewhat as a result of this new distribution, the difference is not usually noticed to the user 101. Therefore, the area-indicating-capacitance 1807 gives a useful indication of the contact-area 109, regardless of the orientation of the input device 105. In particular, the interpolation performed at step 608 makes it possible for the user 101 to obtain a desired effect, by covering more or less of the input device 105 with their hands 1201 and 1202. This simple hand-area-sensor 1709, in combination with the method of interpolation shown at step 608, permits a robust, reliable and low cost input device 105 to be manufactured.

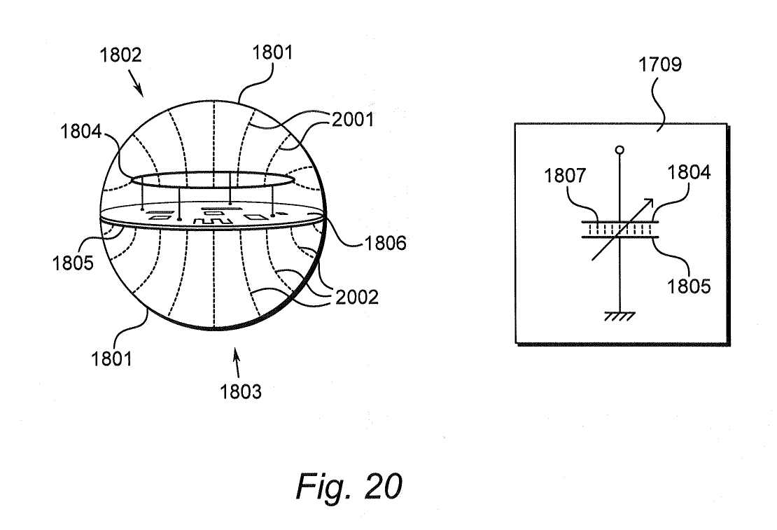

FIG. 20

In an embodiment, the electrodes 1804 and 1805 take a different form to that shown in FIG. 18. This embodiment is shown in FIG. 20. The first capacitive electrode 1804 is formed by a ring of wire offset from the PCB 1806. An electrical field is projected outwards to the outer-surface 1801 of the first-hemisphere 1802, as indicated by first electrical field lines 2001. The second capacitive electrode 1805 is formed by a conductive ground plane of the PCB 1806. In an embodiment, a combination of multiple conductive areas on the PCB is used for the second capacitive electrode 1805. An electrical field is projected from the PCB's ground plane 1804 to the outer surface 1801 of the second-hemisphere 1803, as indicated by second electrical field lines 2002. When the user's hands 1201, 1202 are in close proximity to the outer-surface 1801 of the input device 105, the area-indicating-capacitance 1807 increases from a minimum of about eighteen picofarads to a maximum of about eighteen-and-a-half picofarads.

Using the embodiment shown in FIG. 20, the range of the area-indicating-capacitance 1807 is reduced in comparison with the embodiment shown in FIG. 18. However, manufacture is simplified, because the electrodes 1804 and 1805 are integral to the PCB 1806, and there no electrical connections to the outer-surface 1801. In a further embodiment, the first-hemisphere 1802 has the spiral electrode 1804 shown in FIG. 18, and the second-hemisphere uses a conductive plane in the PCB 1806 as the other electrode 1805. In each such embodiment, the first-hemisphere 1802 and the second-hemisphere 1803 are considered as forming the area-indicating-capacitance 1807, whether the electrodes 1804 and 1805 are on the outer-surface 1801, or located further inside the input device 105. The entire input device 105 is a capacitor 1807 whose value indicates the contact-area 109.

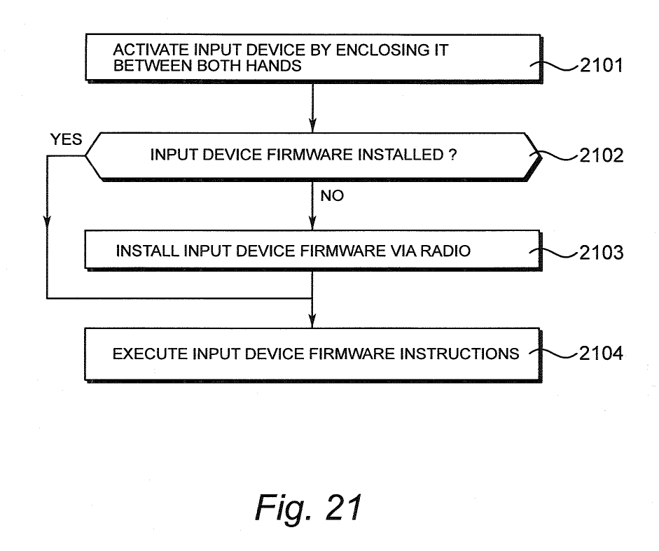

FIG. 21

The steps performed with the input device 105 shown in FIG. 1 are summarised in FIG. 21. At step 2101 the input device 105 is activated by enclosing the input device 105 between the palms of both hands 1201 and 1202. At step 2102 a question is asked as to whether input device firmware 404 is installed. If not, the input device firmware 404 is installed to the FLASH memory 1704 via the radio 1705 at step 2103. At step 2104 input device firmware instructions 404 are executed. The step 2103 may also be performed in order to update or upgrade to a newer version of the firmware 404.

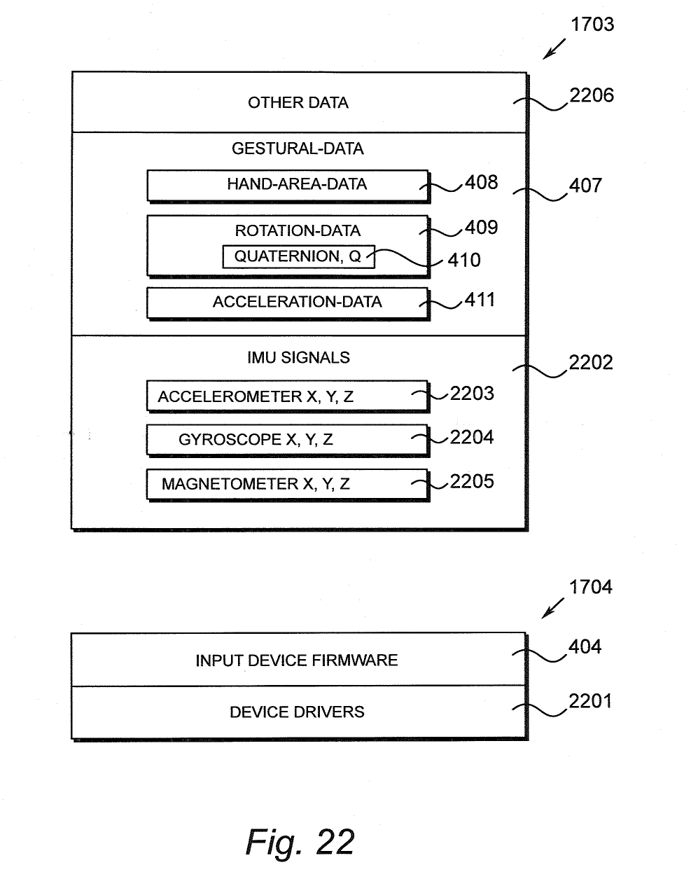

FIG. 22

Contents of input device RAM 1703 and FLASH 1704 during operation of step 2104 shown in FIG. 21, are detailed in FIG. 22. At 2201, device drivers include instructions to enable the device-processor 1702 to communicate with the radio 1705, battery and power management circuit 1707, haptics circuit 1708, hand-area-sensor 1709 and rotation-detector 1710. the FLASH memory 1704 also includes input device firmware instructions 404.

Input device RAM 1703 includes IMU signals 2202 comprising three-axis-accelerometer data samples 2203, three-axis-gyroscope data samples 2204 and three-axis-magnetometer data samples 2205. The input-device 105 generates gestural-data 407 by executing the input device firmware instructions 404 on the device-processor 1702. The gestural-data 407 includes hand-area-data 408, rotation-data 409 including the quaternion, Q, 410, and acceleration-data 411. Other data 2206 includes temporary variables used during the generation of the gestural-data 407.

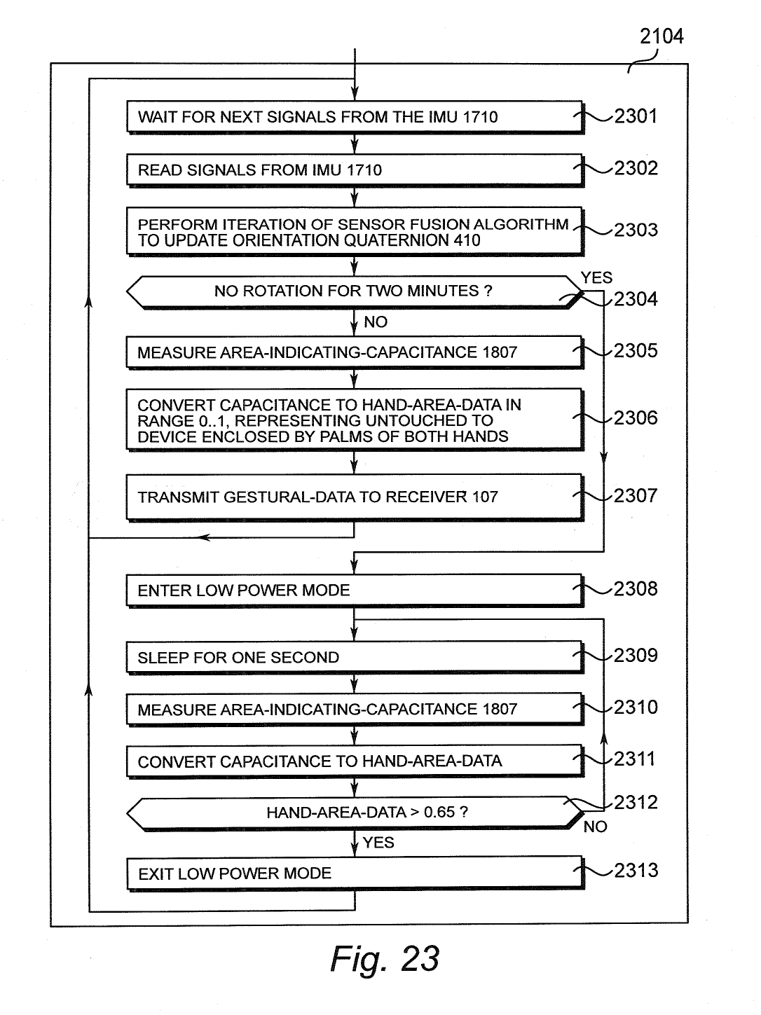

FIG. 23

The step 2104 of executing input device firmware instructions shown in FIG. 21, is detailed in FIG. 23. The inertial-measurement-unit 1710 generates new data every five milliseconds. When the input device 105 is activated, steps 2301 to 2307 are repeated at a rate of two hundred times per second. At step 2301 the device-processor 1702 waits for new IMU signals 2202 to become available. At step 2302 new IMU signals 2202 are read from the rotation-detector 1710. These include the accelerometer samples 2203, gyroscope samples 2204 and magnetometer samples 2205 shown in FIG. 22. The accelerometer samples are scaled and stored as acceleration-data 411, and are also used in the next step to detect tap events.

At step 2303 an iteration is performed of a sensor fusion algorithm. This has the effect of combining accelerometer samples 2203, gyroscope samples 2204 and magnetometer samples 2205 such that the orientation of the input device 105 is known with a high degree of accuracy. Sensor fusion is performed using Sebastian Madgewick's sensor fusion algorithm, available at http://x-io.co.uk/open-source-imu-and-ahrs-alqorithms. Each time step 2303 is performed, the orientation quaternion 410 is incrementally modified, so that, after a short period of initialisation, it continuously tracks the orientation of the input device 105 with respect to the Earth's gravitational and geomagnetic fields.

At step 2304 a question is asked as to whether there has been no rotation of the input device 105 for two minutes. This period of inactivity can be detected by analysing the rotation-data 409. The analysis includes measuring change magnitudes in the components of the orientation quaternion 410. If none of the quaternion's four components change by more than 0.05 in each five millisecond interval for two minutes, the question asked at step 2304 is answered in the affirmative. The input device 105 is then considered as being not in use, and control is directed to step 2307 to deactivate it. Alternatively, if significant rotations have occurred, the input device 105 is considered as being in use, and control is directed to step 2305.

At step 2305 the area-indicating-capacitance 1807 of the hand-area-sensor 1709 is measured. A Capacitance-to-Digital-Converter (CDC) for measuring capacitance is built in to the SOC 1701. The CDC generates a single value proportional to the area-indicating-capacitance 1807. Eight such CDC measurements are made, and then averaged, to reduce noise. At step 2306 the CDC value is converted into a floating point value by subtracting an offset and multiplying by a scaling factor. The offset removes the effect of the parasitic capacitance Cp 1901, and the scaling factor normalises the remaining capacitance range of about three picofarads to a range of zero to one. When the hand-area-data 408 takes a value of zero, this corresponds to a contact-area 109 of zero. When the hand-area-data 408 takes a value of one, this corresponds to the maximum contact-area 109 formed by enclosing the input device 105 in the palms of both hands 1201, 1202.

The hand-area-data 408, rotation-data 409, and acceleration-data 411 are combined into gestural-data 407 and supplied to the radio 1705 at step 2307. The radio 1705 transmits the gestural-data 407 to the receiver 107 in a single packet. Control is then directed to step 2301, and steps 2301 to 2307 are repeated two hundred times per second, in accordance with the sampling rate of the rotation-detector 1710, for as long as the input device 105 is in use.

When the input device 105 is not in use, control is directed to step 2308, where the device-processor 1702 and other components shown in FIG. 17, are put into a low power mode, during which power consumption is reduced to a few microamps. At step 2309, the device-processor 1702 sleeps for one second. At step 2310 the device-processor activates enough of its circuitry to measure the area-indicating-capacitance 1807. At step 2311 the measured capacitance is converted into hand-area-data 408. At step 2312 the hand-area-data is analysed by asking whether the hand-area-data 408 is greater than 0.65. This value is an activation threshold corresponding to the activation gesture of enclosing the input device 105 between both hands. If the hand-area-data is less than the activation threshold, control is directed back to step 2309, where the device-processor 1702 sleeps for another second before performing another measurement of the area-indicating-capacitance 1807. Alternatively, if a large-enough contact-area 109 is detected, at step 2313 the device-processor 1702 and other components exit the low power mode, and control is directed back to step 2301.

The steps of FIG. 23 show how the input device 105 generates a stream of gestural-data 407 to the external-processing-device 106. Also shown, is the mechanism for activating and deactivating the input device 105, which is necessary because it is spherical, and there is no place for a conventional switch or on/off button. Alternative switching mechanisms are ineffective. For example, if the accelerometer 1711 is used to activate the input device 105 in response to a sharp tap, problems will occur when the device receives ordinary knocks and movements during transportation. By comparison, the increase in capacitance caused by enclosure between the palms of both hands does not occur by accident. One way of achieving the same effect is to wrap the input device 105 in aluminium foil. This and equivalent capacitance phenomena, cannot occur unless done deliberately. Periodically measuring the area-indicating-capacitance 1807 provides a reliable method for activating the device.

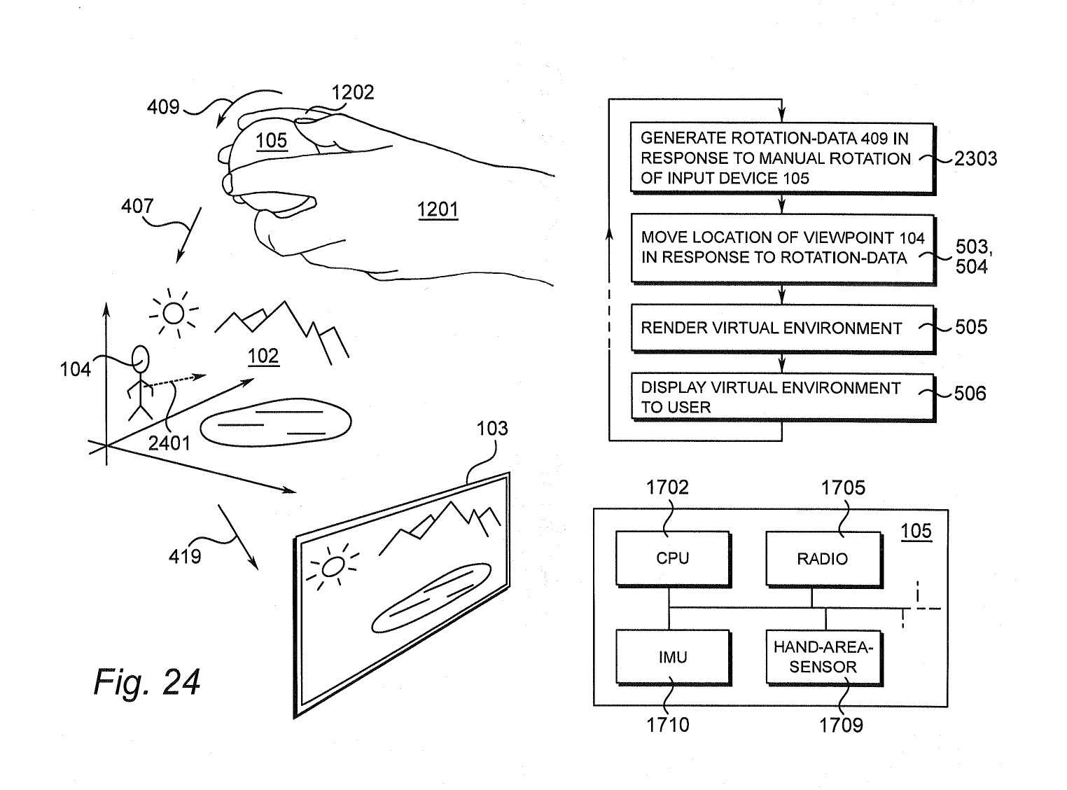

FIG. 24

Locomotion with the input device 105 is summarised in FIG. 24. Rotation-data 409 is generated in response to manual rotation of the input device 105 by the user's hands 1201, 1202. The rotation-data 409 is produced by the process of sensor fusion performed at step 2303 also shown in FIG. 23. Sensor fusion 2303 processes signals 2202 from the rotation-detector 1710 that is contained within the input device 105. The rotation-data 409 is included in gestural-data 407 supplied to the external processing device 106. The external processing device moves 503, 504 the location of the user's viewpoint 104 in response to the rotation-data 409. The user's viewpoint 104 is part of the virtual environment 102, which is rendered at step 505 to generate image data 419. At step 506 the image data 419 is supplied to the display 103, enabling the user 101 to navigate the virtual environment 102.

User locomotion 2401 is achieved by the user 101 in response to their manual rotation and manipulation of the input device 105. Rotations 409 are translated into forwards 2401, backwards or strafing movements, and or rotations, according to the contact-area 109. The viewpoint 104 is adjusted according to these movements and rotations. The virtual environment 102 is then rendered from the perspective of the user's adjusted viewpoint 104, and displayed to the user 101 on the display 103.

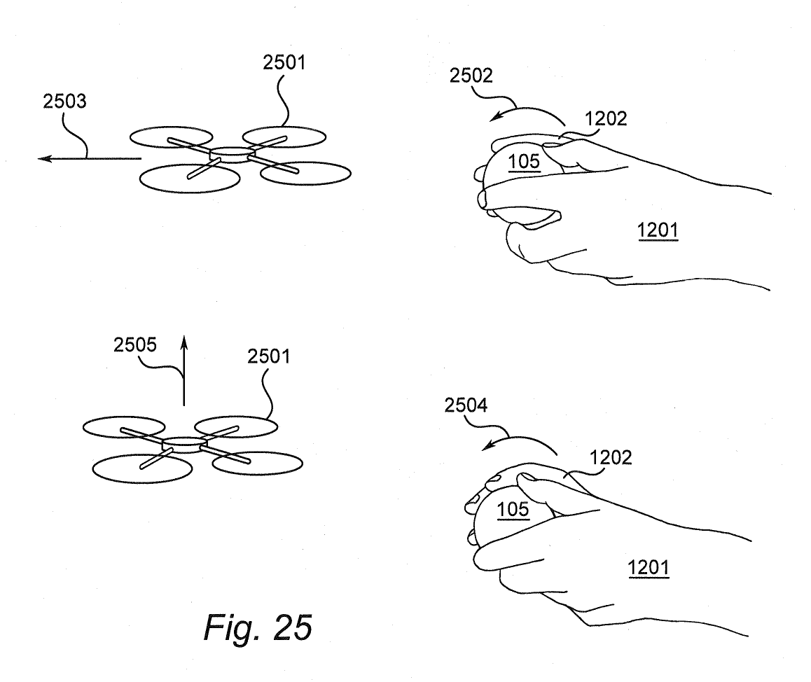

FIG. 25

In an embodiment, the input device 105 may be used to facilitate navigation of an aircraft. In FIG. 25, a quadcopter, or drone 2501, is controlled from a remote location by the user 101, holding the input device 105 in left and right hands 1201 and 1202 respectively. When held lightly in the hands 1201, 1202, a forward rotation 2502 of the input device 105 causes the drone 2501 to fly in a forwards direction 2503. Rotating the input device 105 in the opposite direction causes the drone 2501 to fly in the opposite direction.

The input device 105 may be held more tightly in the user's hands 1201, 1202, covering a larger area 109 of the input device's surface. Under these conditions, a forward rotation 2504 causes the drone 2501 to fly directly upwards. A reverse rotation causes the drone 2501 to fly directly downwards.

Interpolation between the horizontal and vertical movement of the drone 2501 is performed in accordance with the surface area 109 of the input device 105 covered by the user's hands 1201, 1202, as shown by the calculations performed in FIG. 10. Such interpolation enables the drone to move in a diagonal flight vector, combining horizontal and vertical components. The direction of flight may further be defined by rotating the input device 105 about its vertical axis, causing the drone 2501 to rotate correspondingly.

During such operations, the user 101, may view the drone 2501 directly by eye, or by wearing a headset in which images from a camera on the drone are supplied to the user 101, to provide a view from the drone's perspective. In each such case, the user 101 is immersed in a virtual environment provided either by imagining or electronically viewing the real world from the drone's point-of-view. An advantage of the input device 105, is that the psychological sense of immersion is increased beyond that possible using a conventional joystick remote control, because the rotations of the input device 105 are more directly associated with movements of the drone 2501.

As a result, the user 101 is able to navigate the three-dimensional environment occupied by the drone 2501, without the need to learn complex controls. The rotation-detector generates rotational gestural-data in response to the manual rotation 2502, 2504 of the input device 105, and additional gestural-data is generated in response to the area 109 of the user's hands supporting the input device during a manual rotation 2502, 2504. The gestural-data is then transmitted to the drone 2501. In an embodiment, the gestural-data is transmitted in two stages. In a first stage, the input device 105 transmits the gestural-data to an external-processing-device where it is transmitted with a more powerful radio transmitter, to the drone 2501. In an embodiment, the input device 105 transmits gestural-data directly to the drone 2501, which includes an external-processing-device to process the gestural-data and to update its flight electronics in accordance with the gestures 2502, 2504 made by the user 101.

1. An apparatus for supplying gestural-data to an external-processing-device, thereby allowing said external-processing-device to move a viewpoint in a three-dimensional virtual environment and to render said virtual environment from said viewpoint, implemented as a substantially spherical manually-rotatable input device supported in the hands of a user, comprising:
a rotation-detector configured to generate gestural-data in response to manual rotation of the substantially spherical manually-rotatable input device, and
a wireless transmitter for transmitting said gestural-data to said external-processing-device.

2. The apparatus of claim 1, wherein said rotation-detector is an inertial-measurement-unit.

3. The apparatus of claim 2, wherein said inertial-measurement-unit includes a three-axis-gyroscope.

4. The apparatus of claim 2, wherein said inertial-measurement-unit includes a three-axis-accelerometer.

5. The apparatus of claim 2, wherein said inertial-measurement-unit includes a three-axis-magnetometer.

6. The apparatus of claim 1, wherein said rotation-detector includes:
a three-axis-gyroscope producing first-data;
a three-axis-accelerometer producing second-data;
a three-axis-magnetometer producing third-data; and
a device-processor for producing said gestural-data by combining said first-data with said second-data and said third-data in a process of sensor fusion.

7. The apparatus of claim 1, further comprising a hand-area-sensor and said rotation-detector is configured to generate additional said gestural-data in response to measurements made with said hand-area-sensor.

8. A method of adjusting the location of a viewpoint in a three-dimensional environment, comprising the steps of:
generating rotation-data in response to a manual rotation of a substantially spherical hand-supported input device supported in the hands of a user;
wirelessly transmitting said rotation-data to an external-processing-device; and
moving the location of a viewpoint in said three-dimensional environment in response to said received rotation-data.

9. The method of claim 8, further including the step of rendering image data from said three-dimensional environment with respect to said viewpoint location.

10. The method of claim 9, further including the step of displaying said rendered image data to said user.

11. The method of claim 8, wherein said step of moving the location includes the steps of:
moving said viewpoint forwards in said three-dimensional environment in response to a pitch-rotation of said input device about an x axis;
translating said viewpoint sideways in said three-dimensional environment in response to a roll-rotation of said input device about a z-axis; and
yaw-rotating said viewpoint in said three-dimensional environment in response to a yaw-rotation of said input device about a y-axis.

12. The method of claim 11, wherein:
said step of moving the location further includes the step of generating hand-area-data in response to a contact-area of said user's hands in close proximity with an outer-surface of said input device; and
said step of moving the viewpoint forwards includes the step of multiplying said forward-rotation by a scaling factor generated in response to said hand-area-data.

13. The method of claim 12, wherein said hand-area-data is obtained in response to measuring a capacitance.

14. The method of claim 12, further including the step of transmitting said hand-area-data as part of said gesture-data.

15. The method of claim 12, further including the step of analysing said hand-area-data to identify a gesture.

16. The method of claim 8, wherein said step of moving the location of a viewpoint includes the step of moving said external-processing-device.

17. The method of claim 8, wherein said step of moving the location of a viewpoint is implemented by zooming in on an image.

18. A system for presenting immersive images to a user via a display device, in which said user has a viewpoint within a three-dimensional virtual environment, the system comprising:
a substantially spherical manually-rotatable hand supported input device with:
a rotation-detector,
a device-processor and
a wireless transmitter,
wherein said device-processor generates gestural-data in response to manual rotation of said input device measured by said rotation-detector, and said transmitter transmits said gestural-data;
an external-processing-device, which:
receives said gestural-data wirelessly,
moves said user viewpoint in said three-dimensional virtual environment in response to manual rotation of said input device and
renders image-data from said virtual environment with respect to said viewpoint; and
a display device, in which said display device presents said image data to a user;
wherein said user experiences locomotion within said virtual environment in response to rotation of said input device.

19. The system of claim 18, wherein said external-processing-device is configured to:
move said viewpoint forwards in said virtual environment in response to a pitch-rotation of said input device about an x-axis;
translate said viewpoint sideways in said virtual environment in response to a roll-rotation of said input device about a z-axis; and
yaw-rotate said viewpoint in said virtual environment in response to a yaw-rotation of said input device about a y-axis.

20. The system of claim 18, wherein:
said input device includes a hand-area-sensor and is configured to transmit hand-area-data as part of said gestural-data; and
said external-processing-device is configured to modify said movement of said user viewpoint in response to said hand-area-data.
